(19) United States
(12) Patent Application Publication
(10) Pub. No.: US 2026/0367726 A1
(43) Pub. Date: Nov. 19, 2026

(54) CAPACITIVE TOUCH PROCESSING USING MEDIAN BASELINE ESTIMATION AND BEND COMPENSATION, AND RELATED METHODS AND APPARATUSES

(71) Applicant: Microchip Touch Solutions Limited, Wokingham (GB)

(72) Inventors: Predrag D. Vukovic, Winchester (GB); Philippe-Louis de Frechou, Didcot (GB)

(21) Appl. No.: 19/575,463

(22) Filed: Mar. 23, 2026

Related U.S. Application Data
(60) Provisional application No. 63/777,304, filed on Mar. 25, 2025.

(51) Int. Cl. G06F 3/041; G06F 3/044

(52) U.S. Cl. CPC G06F 3/0416; G06F 3/0445; G06F 3/0446; G06F 2203/04111

(57) ABSTRACT

A method includes receiving capacitive measurement values of a number of capacitive nodes of a touch sensor; computing, as a baseline estimate, a median estimate of the capacitive measurement values of the capacitive nodes; computing, for respective capacitive nodes, a delta value at least partially based on differences between the capacitive measurement values of the respective capacitive nodes and the baseline estimate; and computing a bend component value of a respective one of the capacitive nodes at least partially based on an interpolation between the delta value of the respective capacitive node and the baseline estimate according to an interpolation factor of the respective capacitive node.

### CROSS-REFERENCE TO RELATED APPLICATION

This application claims the benefit under 35 U.S.C. § 119(e) of U.S. Provisional Patent Application Ser. No. 63/777,304, filed Mar. 25, 2025, the disclosure of which is hereby incorporated herein in its entirety by this reference.

### TECHNICAL FIELD

Examples relate, generally, to capacitive touch systems. More particularly, some examples relate to capacitive touch processing for touchscreens of capacitive touch systems. Additionally, related methods, apparatuses, and systems are disclosed.

### BACKGROUND

A typical touch interface system may incorporate touch sensors that respond to an object in close proximity to, or physical contact with, a contact sensitive surface of a touch interface system. Such responses may be captured and interpreted to infer information about the contact, including a location of an object relative to the touch interface system. Touchpads used with personal computers, including laptop computers and keyboards for tablets, often incorporate or operate in conjunction with a touch interface system.

Displays often include touch screens that incorporate elements of a touch interface system to enable a user to interact with a graphical user interface (GUI) and/or computer applications. Examples of devices that incorporate a touch display include portable media players, televisions, smart phones, tablet computers, personal computers, and wearables such as smart watches, just to name a few. Further, control panels for automobiles, appliances (e.g., an oven, refrigerator or laundry machine) security systems, automatic teller machines (ATMs), residential environmental control systems, and industrial equipment may incorporate touch interface systems with displays and housings, including to enable buttons, sliders, wheels, and other touch elements.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a front perspective view of a system including a touchscreen device having a touchscreen;

FIG. 2A is a schematic diagram of a capacitive touch system including a touch sensor for the touchscreen of FIG. 1;

FIG. 2B is a schematic diagram of a touch controller of the touch sensor of FIG. 2A;

FIG. 3A is a top-down view of a multi-layer arrangement of the touch sensor;

FIG. 3B is a cross-sectional view of the multi-layer arrangement of the touch sensor of FIG. 3A;

FIG. 4 is a schematic diagram of an apparatus including the capacitive touch system having the touch sensor and the touch controller;

FIGS. 5A, 5B, and 5C are respective sets of plots depicting example touch processing data to illustrate at least some objectives of the disclosure;

FIG. 6 is a flowchart of a method of capacitive touch processing in a touch sensor, according to one or more examples;

FIG. 7 is a flowchart of a method of median estimation processing for computing a median estimate of a number of capacitive measurement values, according to one or more examples;

FIG. 8 is a flowchart of a method of interpolation factor processing for computing an interpolation factor for bend morphing, according to one or more examples;

FIG. 9 is a flowchart of a method of capacitive touch processing in a touch sensor, according to one or more examples;

FIGS. 10A and 10B are respective example groups of plots illustrating a relationship between a baseline estimate and a median of capacitive measurement values, according to one or more examples;

FIGS. 11A and 11B form a flowchart of a method of computing a median estimate of capacitive measurement values as a baseline estimate in a touch sensor, according to one or more examples;

FIG. 11C is an example sequence of successive changes in data values and array contents during an iterative median estimation process, according to one or more examples;

FIG. 12 is a processing flow diagram associated with a bend compensation module, according to one or more examples;

FIG. 13 is an example plot depicting a spatial distribution of capacitive signal values along an X line (or drive line) of capacitive nodes of a touch sensor, and further illustrating bend morphing applied along the X line, according to one or more examples;

FIG. 14 is an example plot depicting a relationship between a spatial signal gradient and an interpolation factor used for bend compensation processing, according to one or more examples;

FIG. 15 is an example plot depicting a relationship between a difference signal (Δ−median) and a bend morphing response used in bend compensation processing, according to one or more examples; and

FIG. 16 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Capacitive touch sensors produce electrical measurements that are analyzed to determine the presence and location of touch events. As sensing arrays increase in size and operate in environments with closely coupled electronic components, the processing of these measurements becomes more challenging. Background capacitance variations and noise sources can obscure touch-induced signal changes, making reliable touch detection even more dependent on effective signal processing techniques.

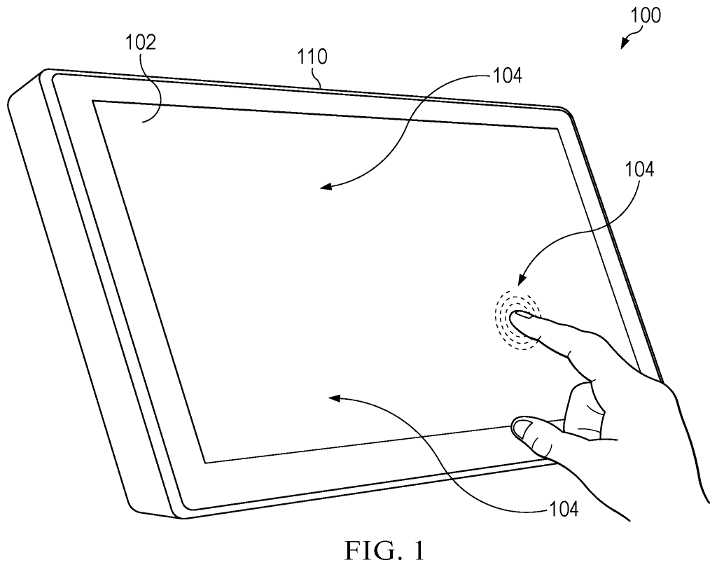

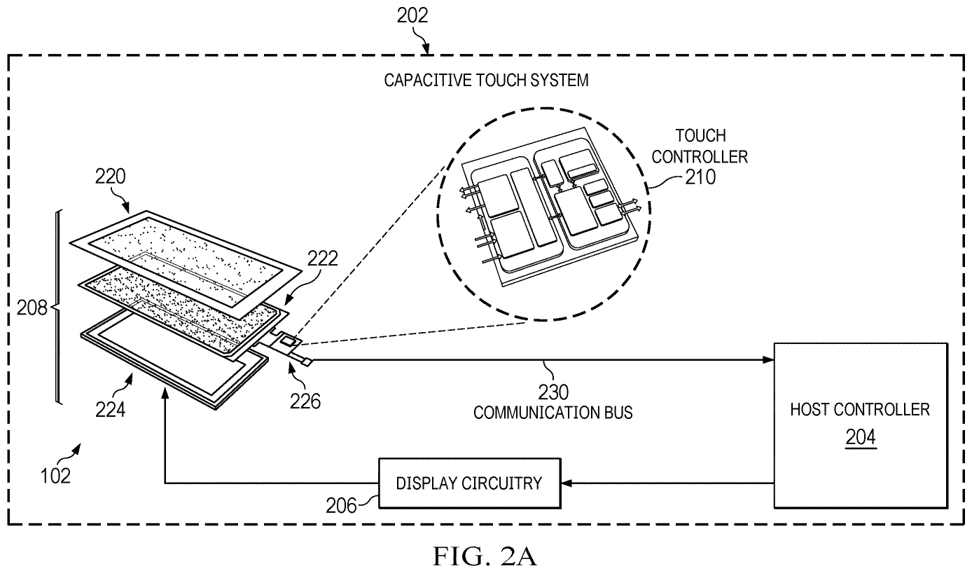

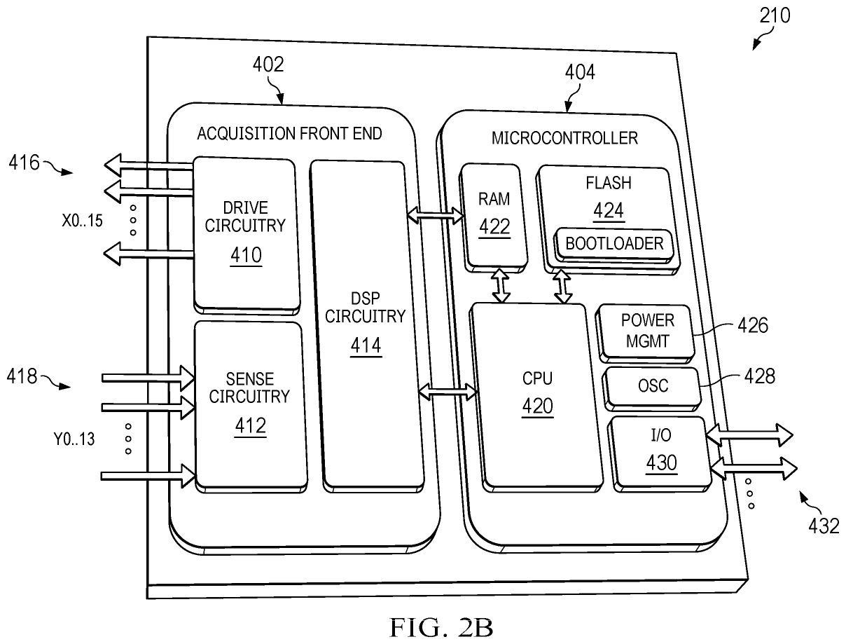

FIG. 1 is a front perspective view of a system 100 including a touchscreen device 110 having a touchscreen 102. In one or more examples, touchscreen 102 may utilize a capacitive touch system for capacitive touch-sensing operations (e.g., a capacitive touch system 202 of FIG. 2 to be discussed below).

In general, the capacitive touch system of touchscreen device 110 of FIG. 1 operates by detecting electrical properties of a conductive object (e.g., a human fingertip) to determine touch input within a capacitive touch-sensitive area 104. Touchscreen 102 typically includes layers coated with a transparent conductive material, such as Indium Tin Oxide (ITO). The transparent conductive material holds a small electrical charge distributed across a grid of touch-sensing regions within capacitive touch-sensitive area 104. With the help of a touch controller, each of these sensing regions contains multiple touch points that regularly measure changes in capacitance. When a user's fingertip (or other object) comes into contact with the touchscreen 102 at a touch location, it disturbs the electrostatic field at specific touch points within the sensing regions. Signals from the sensing regions are provided to the touch controller that calculates precise coordinates of the touch location. A host controller of the capacitive touch system interprets the coordinates of the touch location as a command, such as a tap, a swipe, or a pinch, and may invoke a function in response to the command.

Capacitive touchscreens are highly accurate, durable, and multi-touch capable, and are therefore widely used across many industries. Thus, touchscreen device 110 may be one of any number of different types of devices. As examples, touchscreen device 110 may be or be part of an automotive display device (e.g., in an SDV display, as an infotainment system or in-vehicle infotainment (IVI) system), a personal computer (PC), an all-in-one PC, a laptop, a tablet, a 2-in-1 hybrid device (e.g., laptop/tablet), a smartphone, a point-of-sale (PoS) terminal, a gaming device, a smart home device (e.g., to monitor, control, and/or manage lighting, temperature, security, entertainment, and household appliances), a factory control panel device (e.g., to monitor, control, and/or manage machinery or processes), or a medical device (e.g., to monitor, control, and/or manage patient monitoring systems, ultrasound machines, infusion pumps, electronic medical record (EMR) terminals, or diagnostic imaging devices), to name but a few.

FIG. 2A is a schematic diagram of a capacitive touch system 202 including a capacitive touch sensor 222 (hereinafter, a “touch sensor 222”) for a touchscreen. In one or more examples, capacitive touch system 202 is part of a touchscreen device, such as touchscreen device 110 of FIG. 1. Capacitive touch system 202 includes touchscreen 102, a display circuitry 206, and a host controller 204. In general, touchscreen 102 comprises a multi-layered input/output (I/O) device 208 including a touch controller 210. Multi-layered I/O device 208 comprises one or more layers of a front panel 220, one or more layers of touch sensor 222, and one or more layers of a display 224. Typically, in multi-layered I/O device 208, front panel 220 is overlaid on top of touch sensor 222, which is overlaid on top of display 224.

In one or more examples of FIG. 2A, touch controller 210 is mounted on and electrically connected to a flexible cable 226, and shown in an enlarged view in a magnifying circular window for better clarity. Multi-layered I/O device 208 of touchscreen 102 is operably coupled to touch controller 210 via flexible cable 226. In particular, touch sensor 222 is operably coupled to touch controller 210 for capacitive touch detection. Touch controller 210 is further coupled to host controller 204 via a communication bus 230 via flexible cable 226. Communication bus 230 may be any suitable type of communication bus, such as an Inter-Integrated Circuit (I2C) bus, a Universal Serial Bus (USB), or a Serial Peripheral Interface (SPI) bus, without limitation. Display 224 is operably coupled to display circuitry 206, which is operably coupled to host controller 204. Display 224 may be any suitable type of display, such as a liquid crystal display (LCD), an Organic Light-Emitting Diode (OLED) display, or an Active Matrix Organic Light Emitting Diode (AMOLED) display, without limitation.

Touch controller 210 includes (e.g., dedicated) processing circuitry for processing signals of touch sensor 222 of multi-layered I/O device 208. For example, touch controller 210 is to receive raw signals associated with any capacitance changes at touch sensor 222 (i.e., from user touches), process the raw signals to determine location(s) and/or state(s) of any detected touch inputs, and translate that data into detected touch position data (e.g., detected x-y touch coordinates). Touch controller 210 communicates the detected touch position data (e.g., detected x-y touch coordinates) to host controller 204 over communication bus 230. Host controller 204 may receive and respond to the detected touch position data by performing operations or functions associated with the detected touch position data.

Host controller 204 is considered to be the main or primary controller of the device, and therefore operates to control one or more main or primary operations of the device. Main or primary operations of the device may include performing functions associated with application-specific processing of the device (e.g., functions typically associated with the application or the type of device, whether it be an automotive display device, a PC, a laptop, a tablet, a 2-in-1 hybrid device, a smartphone, a PoS terminal, a gaming device, a smart home device, a factory control panel device, a medical device, and so on). Host controller 204 receives detected touch position data via touch sensor 222, and in response, communicates signals to display circuitry 206 to display information in display 224 and performs the application-specific functions associated with the detected touch position.

FIG. 2B is a schematic diagram of touch controller 210 of touch sensor 222 of FIG. 2A. In one or more examples, touch controller 210 of FIG. 2B includes an acquisition front end 402 and a microcontroller 404. Acquisition front end 402 includes a drive circuitry 410, a sense circuitry 412, and a digital signal processing (DSP) circuitry 414 (e.g., a DSP processing and control circuitry). Microcontroller 404 includes a central processing unit (CPU) 420, an oscillator 428, an I/O interface circuitry 430 for one or more communication buses 432, and a power management module 426. One or more clock signals may be generated from oscillator 428 and used for timing of circuitry (e.g., CPU 420, DSP circuitry 414, and so on). Microcontroller 404 also includes memory, including RAM 422 and flash memory 424 (e.g., including a bootloader process). In one or more examples, an application may be stored in flash memory 424 to control operation of CPU 420 and/or DSP circuitry 414.

In one or more examples, all or most of the components of touch controller 210 are provided in IC, such as a touch controller IC, for use in a computing device or terminal (e.g., touchscreen device 110 of FIG. 1). In one or more examples, touch controller 210 is configured with a circuit design based on a maXTouch® touch controller. maXTouch® is a registered trademark of Microchip Technology Incorporated, of Chandler, Arizona, USA.

In one or more examples, touch controller 210 includes acquisition front end 402 for processing signals of a capacitive touch sensor. Here, DSP circuitry 414 is operably coupled to drive circuitry 410, and drive circuitry 410 is coupled to a number of drive lines 416. In one or more examples, drive circuitry 410 is referred to as transmit (Tx) circuitry and the number of drive lines 416 is referred to as a number of transmit lines. In one or more examples of FIG. 2B, the number of drive lines 416 includes sixteen (16) drive lines, which are designated in the figure as X0 through X15. DSP circuitry 414 is also operably coupled to sense circuitry 412, and sense circuitry 412 is coupled to a number of sense lines 418. In one or more examples, sense circuitry 412 is referred to as receive (Rx) circuitry and the number of sense lines 418 is referred to as a number of receive lines. In one or more examples of FIG. 2B, the number of sense lines 418 includes fourteen (14) sense lines, which are designated in the figure as Y0 through Y13. In one or more examples, the number of drive lines 416 are provided as output pins of the touch controller IC, and the number of sense lines 418 are provided as input pins of the touch controller IC. In one or more examples, I/O interface circuitry 430 may be coupled to output pins (e.g., provided with one or more connectors).

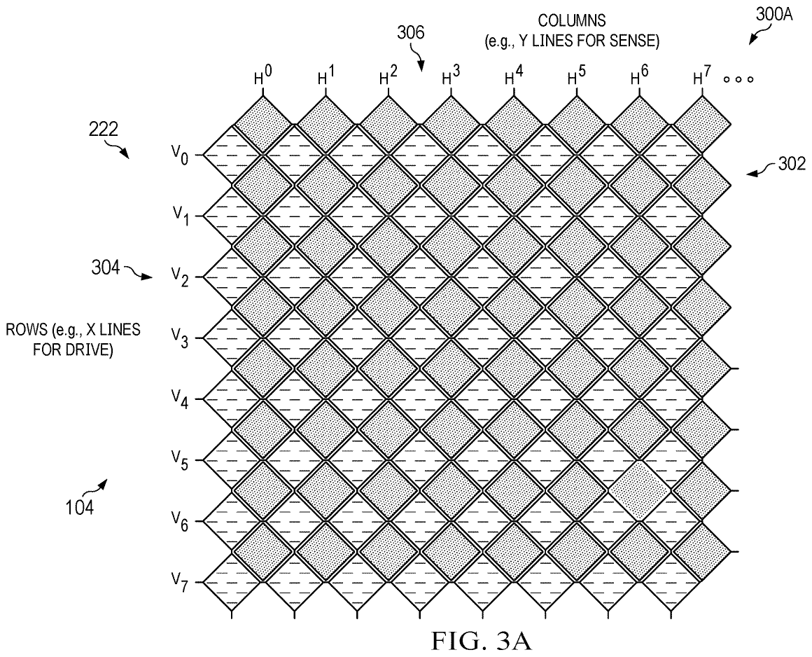

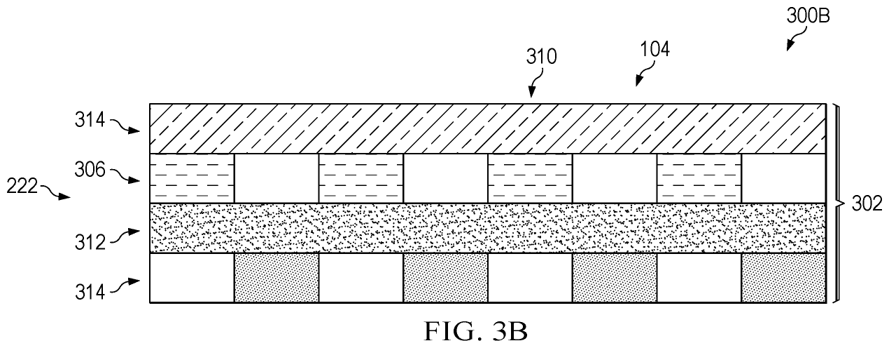

FIG. 3A is a top-down view 300A of a multi-layer arrangement 302 of touch sensor 222. FIG. 3B is a cross-sectional view 300B of multi-layer arrangement 302 of touch sensor 222 of FIG. 3A.

Touch sensor 222 of FIGS. 3A and 3B is adapted for mutual capacitance touch detection. With reference to FIG. 3A, multi-layer arrangement 302 of touch sensor 222 includes a drive electrode layer 304 including drive electrodes (e.g., indicated by horizontal hatching, or single-line or linear hatching, in FIG. 3A) and a sense electrode layer 306 including sense electrodes (e.g., indicated by grid hatching, or cross or plus hatching, in FIG. 3A). In FIG. 3B, it is shown that sense electrode layer 306 is stacked over drive electrode layer 304, separated by an adhesive layer 312, and covered with a protective layer 314 (e.g., Perspex or glass). Adhesive layer 312 is typically relatively firm or inflexible, as any physical movement of sense electrode layer 306 relative to drive electrode layer 304 would cause undesirable changes in capacitance.

In the stacked arrangement, drive electrode layer 304 including the drive electrodes and sense electrode layer 306 including the sense electrodes are arranged in an array of interacting electrodes comprising capacitive nodes (e.g., mutual capacitance nodes) at which changes in capacitance are sensed. In one or more examples, the horizontally-connected electrodes of drive electrode layer 304 (e.g., rows, driven by “X” or drive lines) correspond to changes that vary vertically (e.g., V0 through V7) to help determine the Y position. The vertically-connected electrodes of sense electrode layer 306 (e.g., columns, sensed at “Y” or sense lines) correspond to changes that vary horizontally (e.g., H0 through H7) to help determine the X position.

In contemplated operation with respect to capacitive touch-sensitive area 104, the touch controller is used to sequentially excite respective drive lines (e.g., X lines) with an AC voltage. At each capacitive node (e.g., intersection of an X-line and Y-line) a small mutual capacitance (Cₘ) is formed. When a finger touches at or near a node (e.g., a touch 310 of FIG. 3B), it disturbs the electric field, reducing Cₘ at that point (e.g., part of the electric field couples to the human body). A capacitive coupling strength at each intersection may be detected at respective sense lines (e.g., Y lines). By scanning all intersections, the touch controller can map the exact touch location.

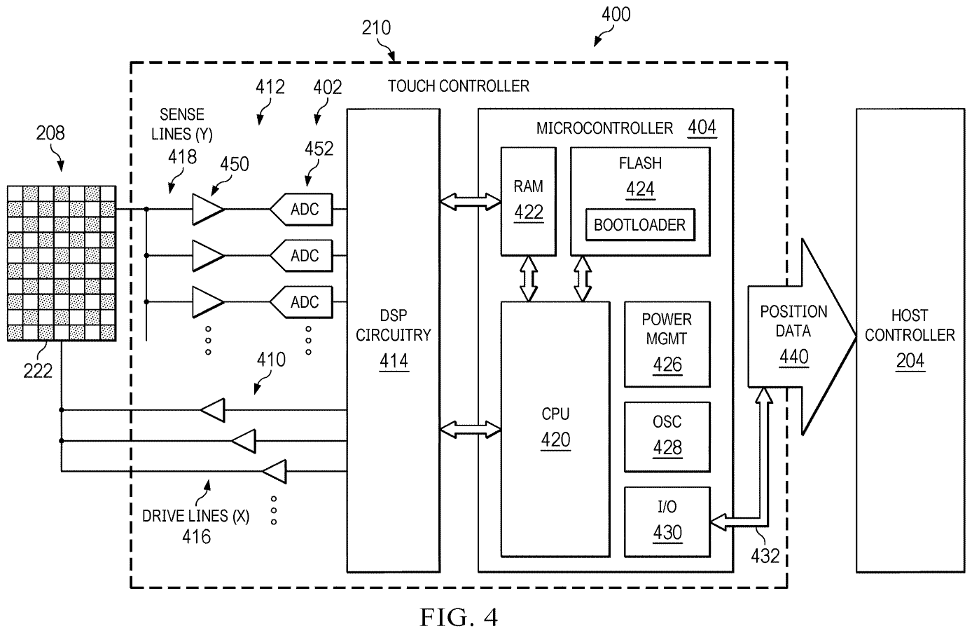

FIG. 4 is a schematic diagram of an apparatus 400 including the capacitive touch system having touch sensor 222 and touch controller 210, according to one or more examples. Some of the features in FIG. 4 are the same as or similar to some of the features in FIGS. 2A and 2B, as indicated by the same reference numbers, unless expressly described otherwise. In one or more examples, apparatus 400 of FIG. 4 may be part of the touchscreen device 110 of FIG. 1. The capacitive touch system of apparatus 400 of FIG. 4 may include some of the basic components of capacitive touch system 202 of FIG. 2A, including the touchscreen (e.g., multi-layered I/O device 208 including at least touch sensor 222), the display circuitry (e.g., display circuitry 206 of FIG. 2A), and host controller 204.

In one or more examples, touch controller 210 of FIG. 4 includes acquisition front end 402 for processing signals of touch sensor 222 for touch detection. In one or more examples, touch sensor 222 may include an array or grid of electrodes arranged in rows and columns (e.g., drive and sense electrodes in FIGS. 3A and 3B). Each intersection point between a row and a column of electrodes form a (capacitive) sensor node. The electrodes may be divided into two sets; a first set coupled to the number of drive lines 416 (e.g., rows or x-lines) of touch controller 210 and a second set coupled to the number of sense lines 418 (e.g., columns or y-lines) of touch controller 210. In one or more examples, drive circuitry 410 may be connected to the rows or x-lines (e.g., X0-X15 for rows 1-15), and sense circuitry 412 may be connected to the columns or y-lines (e.g., Y0-Y13 for columns 1-13).

In one or more examples, drive circuitry 410 includes a number of driver circuits respectively associated with the number of drive lines 416. In one or more examples, sense circuitry 412 includes a number of buffer circuits 450 (or, alternatively, for example, driver amplifier circuits or transimpedance amplifier circuits) and a number of analog-to-digital converters (ADCs) 452. The number of buffer circuits 450 is respectively associated with the number of sense lines 418. The number of buffer circuits 450 is respectively coupled to the number of ADCs 452, which are respectively coupled to inputs of DSP circuitry 414.

In contemplated operation, touch controller 210 may drive an electrical signal (or a “drive signal”) at each row of a sense electrode of touch sensor 222, e.g., sequentially, via the number of drive lines 416 using drive circuitry 410. The drive signal may be any suitable electrical signal, frequency signal, square wave, series of bursts or pulses, alternating voltage or current signals, and so on. Sense circuitry 412 may measure a mutual capacitance as a voltage at each column of a sense electrode of touch sensor 222, e.g., sequentially, via the number of sense lines 418. Based on the measurements, DSP circuitry 414 may detect changes in capacitance/voltage to detect a location of a touch.

When a conductive object, such as a finger, approaches the touchscreen and makes contact with the surface thereof, the finger may form a capacitive coupling between drive and sense electrodes at the point of touch, thereby altering (e.g., lowering) the capacitance at the corresponding intersection point(s). The sense lines may measure the capacitance as a voltage at each of the sense electrodes. Changes in capacitance/voltage (e.g., indicating a decrease in capacitance/voltage) may be analyzed by DSP circuitry 414 to determine touch position data (e.g., the location of the touch), which may be communicated to CPU 420 and/or RAM 422 of microcontroller 404. In one or more examples, microcontroller 404 uses I/O interface circuitry 430 to communicate, at a communication process 440 (“Position Data”), the detected touch position data to host controller 204 via communication bus 432.

In one or more examples, the capacitive touch processing described herein is implemented by software or processor-executable instructions stored in on-chip nonvolatile memory of touch controller 210, such as embedded Flash memory (e.g., Flash 424), ROM, or mask ROM (e.g., fixed firmware). In one or more examples, one or more configuration parameters for the capacitive touch processing are stored in nonvolatile memory, such as EEPROM.

The capacitance measurements generated by capacitive touch system 202 may be processed using various signal processing techniques to identify touch events. The following discussion introduces several signal processing concepts associated with such techniques, including raw capacitance measurements, baseline estimation, and background extraction, which facilitate separating touch-induced signal components from background and noise variations.

Raw capacitance measurements, also referred to as raw measurements or raw data, are digital values produced by the capacitive sensing circuits that represent the “raw” measured capacitance of one or more touch electrodes, prior to background subtraction or higher-level processing. These measurements represent the total sensed capacitance at a given time. Mathematically, the measurements include a background component (i.e., a DC component), together with any touch-induced capacitance changes and unwanted disturbances. The background generally corresponds to a no-touch signal level associated with a capacitive node and may reflect inherent electrode capacitance, parasitic PCB effects, environmental influences such as temperature and humidity, and other static or slowly varying conditions.

Background extraction in capacitive touch sensing is the process of continuously estimating and removing the background component so that meaningful changes (i.e., touch-induced capacitance changes) can be identified. In many implementations, a baseline value is maintained as an estimate of the background level. The difference between the raw capacitance measurement and the baseline value is generally referred to as the delta (i.e., delta=raw−baseline). The delta serves as the working signal for touch detection as it represents changes relative to the background rather than absolute capacitance. The delta contains the desired touch component (e.g., the capacitance increase caused by a finger) together with unwanted disturbances. These disturbances include mechanical effects, such as “bend” or flex-induced capacitance shifts, as well as electrical noise, such as electromagnetic interference (EMI), supply ripple, quantization noise, or interference coupled from an underlying display (e.g., an LCD). “Bend” refers to capacitance variation caused by mechanical deformation or stress of the sensor. For example, the touch surface may be at least partially elastic or compliant such that, during a touch event, it can deform and move closer to an underlying display. This deformation alters the electric field distribution and can change the measured capacitance independently of the touch-induced capacitance component. In contrast, electrical noise refers to electrical fluctuations coupled into the sensing system. Unlike bend, which arises from mechanical deformation, noise arises from electrical sources and may vary more rapidly in time. Although bend and electrical noise are physically distinct phenomena with different causes and characteristics, both appear in the delta as non-touch signal components. These non-touch components may sometimes be collectively referred to as “bend/noise.” Bend/noise degrades signal integrity and reduces signal-to-noise ratio. Effective background extraction and related touch signal processing are used to minimize these unwanted contributions so that true touch events can be reliably detected.

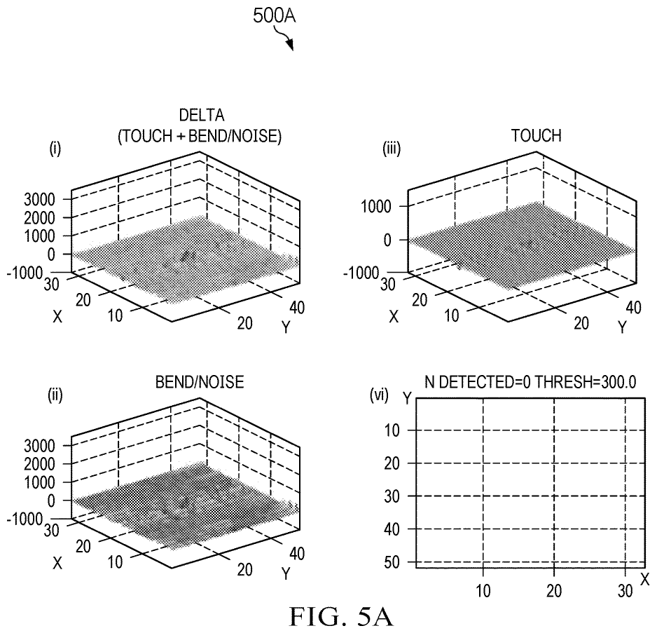

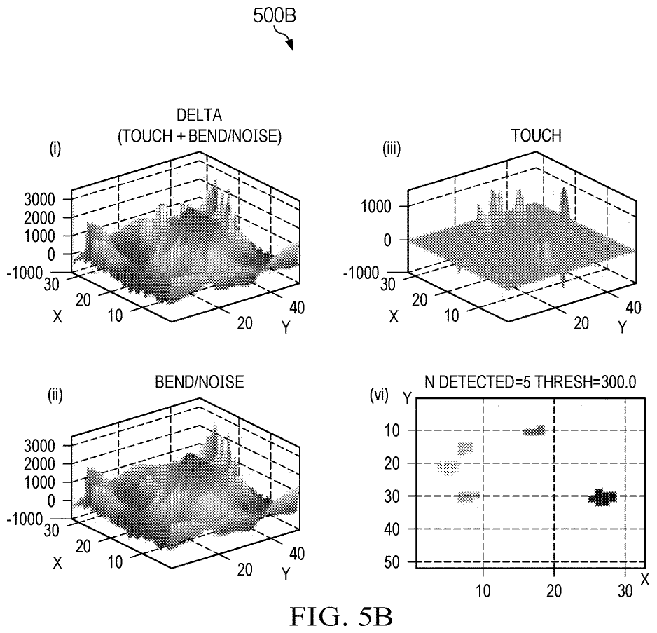

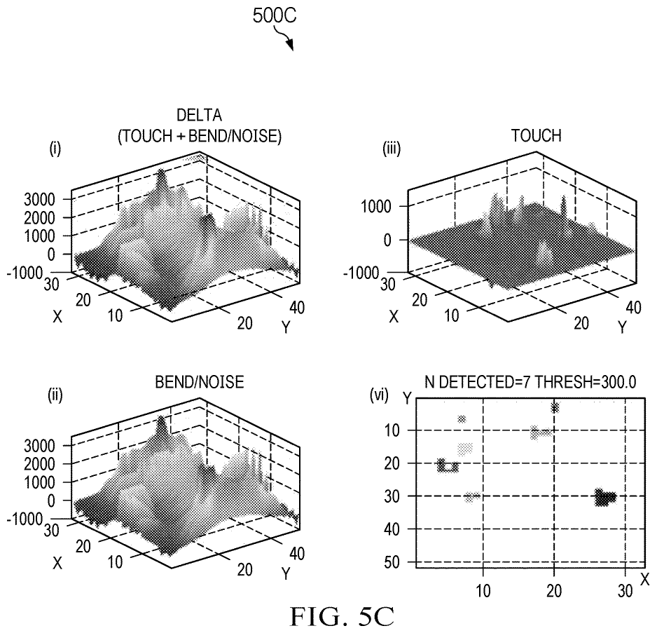

FIGS. 5A, 5B, and 5C are respective sets of plots 500A, 500B, and 500C depicting example touch processing data to illustrate at least some objectives of the disclosure.

In each one of plots (i), (ii), and (iii) in the respective sets of plots 500A, 500B, and 500C, capacitive measurements are presented in three-dimensions: an x-dimension and a y-dimension corresponding to spatial positions of the capacitive nodes (e.g., row and column positions) and a third dimension (e.g., a z-axis) corresponding to the capacitive measurement at each node.

More particularly, each set of plots 500A, 500B, and 500C includes plot (i) of the delta (i.e., the difference between the capacitive measurement value and the baseline, including both touch and non-touch components); plot (ii) of the bend/noise, representing non-touch signal components, including mechanical deformation effects (e.g., bend-or flex-induced capacitance variations) and electrical disturbances, while excluding the touch-induced capacitance component; plot (iii) of the touch-induced capacitance components corresponding to one or more touches; and plot (iv) of touch detections generated from capacitive touch processing at a given threshold (e.g., Thresh=300.0), including simultaneous detections of multiple touches.

In the set of plots 500A of FIG. 5A, it is shown that no touches are presented (e.g., plot (iii)) nor detected (e.g., plot(iv)) and the bend/noise (e.g., plot (ii)) is relatively low. In the set of plots 500B of FIG. 5B, it is shown that five (5) simultaneous touches are presented (e.g., plot (iii)) and accurately detected (i.e. N=5) (e.g., plot (iv)) despite the relatively large bend/noise (e.g., plot (ii)). In the set of plots 500C of FIG. 5C, it is shown that five (5) simultaneous touches are presented (e.g., plot (iii)) but seven (7) simultaneous touches are detected (i.e., N=7) (e.g., plot (iv)) given the relatively large bend/noise (e.g., plot (ii)).

Capacitive touch processing with touch background extraction involves numerous measurement and signal processing operations. In modern capacitive touch systems, processing complexity has increased due to growth in the number of capacitive nodes and reduced spacing relative to noise sources. As discussed earlier, noise pickup from a display (e.g., an LCD) can occur due to close proximity and predominantly capacitive coupling mechanisms. Certain existing approaches to capacitive touch processing are based on linear and non-linear filtering and may therefore be computationally intensive. For example, one approach utilizes lens bending based on non-linear filtering of measured signals (see, e.g., US 2014/0253488). As the number of measurement nodes continues to increase, alternative processing techniques that reduce computational complexity may be desirable.

Described herein are improved systems, methods, apparatuses, and related features for capacitive touch processing with touch background extraction. In one or more examples, touch background is efficiently and effectively extracted while preserving touch amplitude shape and touch presence. In some implementations, the disclosed techniques reduce the number of operations performed per capacitive measurement node and may be implemented without reliance on linear or non-linear filtering techniques. As a result, processing time and power consumption may be improved while maintaining comparable or improved signal-to-noise ratio (SNR) performance relative to existing approaches. Accordingly, per-node processing complexity may be reduced while noise performance is preserved.

According to one or more examples, the disclosed touch processing involves two components that cooperate to reduce computational burden while maintaining signal integrity: (1) a median baseline estimation component; and (2) a bend compensation component. In certain current state-of-the-art approaches, similar functionality can be achieved using filtering techniques, such as non-linear filtering for baseline estimation and anti-causal infinite impulse response (IIR) filtering for bend compensation. However, such techniques typically involve a relatively large number of computational operations and longer processing time.

In one or more examples, the median baseline estimation component includes an iterative baseline estimation process in which capacitive measurement values are partitioned into split arrays to reduce the number of elements processed in successive iterations. Capacitive measurement values are partitioned into first and second arrays based on whether the values are above or below a current candidate median estimate so that successive iterations operate on progressively smaller sets of values. Using approximate median values as candidate estimates further reduces the number of iterations required, providing an effective trade-off between DC level accuracy and computational speed. In one or more examples, the disclosed methods, apparatuses, and systems reduce the number of computational operations performed per node, thereby improving processing efficiency and power consumption.

In one or more examples, the bend compensation component includes bend morphing processing in which an interpolation factor is determined at least partially based on a spatial signal gradient. The interpolation factor controls the extent of bend compensation such that bend compensation is reduced in regions exhibiting sharper spatial signal variation and increased in regions exhibiting smoother spatial variation. The processing distinguishes between noise- or bend-induced signal variations and small touch signals (e.g., signals associated with gloved touches), thereby enabling effective bend compensation while preserving small or weak touch signals.

In one or more examples, the median estimation techniques described herein can replace the use of non-linear filtering for baseline estimation while achieving comparable DC level estimation with fewer computational operations. In one or more examples, the bend morphing techniques described herein can replace the use of IIR filtering for touch extraction while achieving comparable signal quality with fewer computational operations.

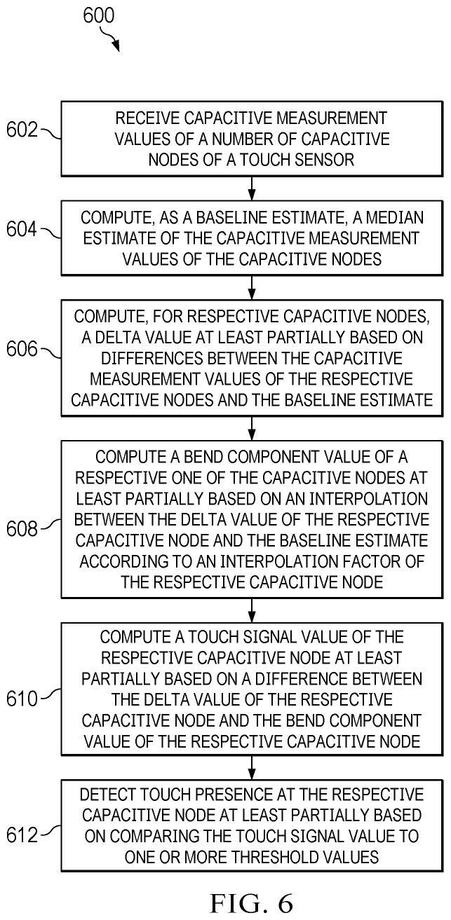

FIG. 6 is a flowchart of a method 600 of capacitive touch processing in a touch sensor, according to one or more examples. As described herein, method 600 and other methods associated with the flowcharts and diagrams described herein (e.g., FIGS. 6, 7, 8, 9, 10A-10B, 11A-11C, and 12-15) may be performed by a touch controller of the touch sensor (e.g., touch controller 210 of touch sensor 222 of FIGS. 2A, 2B, and 4). In one or more examples, the methods may be performed by one or more processors (e.g., an MCU and/or DSP of the touch controller) executing processor-executable instructions stored on a non-transitory processor-readable medium (e.g., memory of the touch controller). In other examples, the methods may be implemented as software modules, with at least portions optionally implemented or accelerated using dedicated hardware.

At an act 602, capacitive measurement values of a number of capacitive nodes of a touch sensor are received.

At an act 604, a median estimate of the capacitive measurement values of the capacitive nodes is computed as a baseline estimate.

At an act 606, respective delta values for the capacitive nodes are computed at least partially based on differences between the capacitive measurement values of the respective capacitive nodes and the baseline estimate

At an act 608, a bend component value of a respective capacitive node is computed at least partially based on an interpolation between the delta value of the respective capacitive node and the baseline estimate according to an interpolation factor of the respective capacitive node.

At an act 610, a touch signal value of the respective capacitive node is computed at least partially based on a difference between the delta value of the respective capacitive node and the bend component value of the respective capacitive node.

At an act 612, touch presence at the respective capacitive node is detected at least partially based on comparing the touch signal value and one or more threshold values.

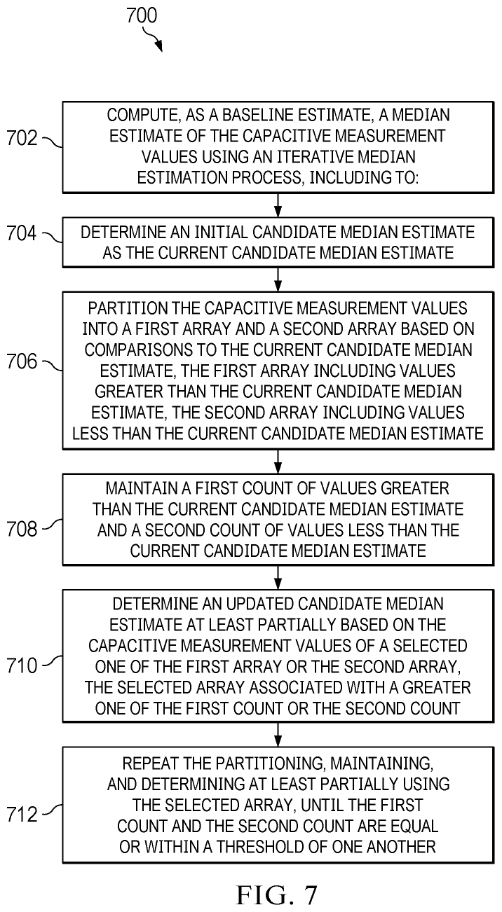

In one or more examples of act 604, the median estimate of the capacitive measurement values is computed as the baseline estimate using an iterative median estimation process. In one or more specific examples, the iterative median estimation process iteratively refines a candidate median estimate by repeatedly partitioning capacitive measurement values into values below and above a current candidate median estimate, until a final median estimate is identified. In one or more examples, the median estimate of the capacitive measurement values is computed as the baseline estimate using a method 700 shown and described in relation to FIG. 7.

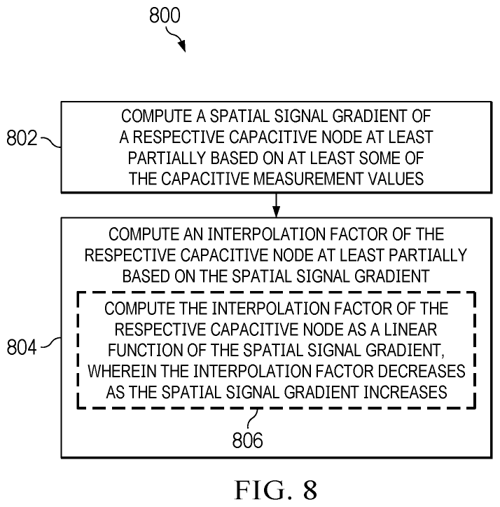

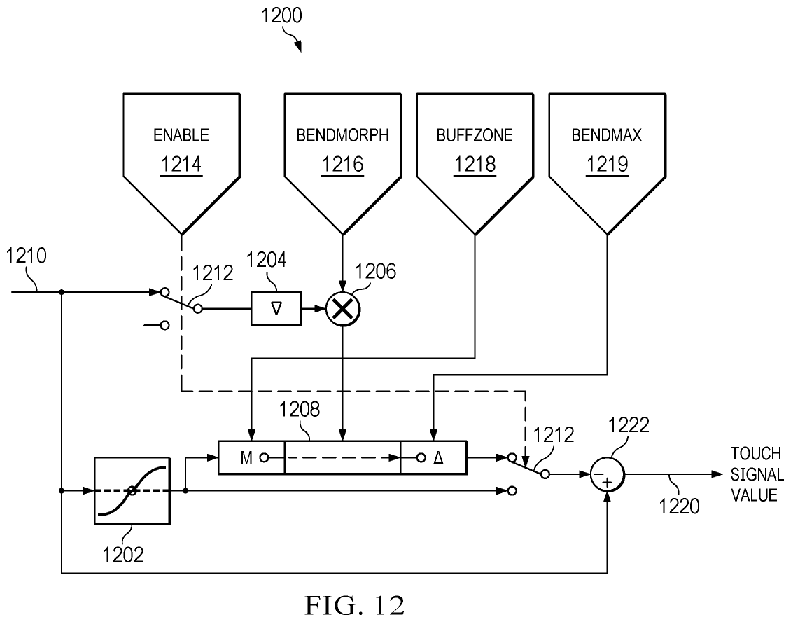

In one or more examples of act 606, the bend component value of the respective capacitive node is computed using an interpolation factor at least partially based on a spatial signal gradient of the respective capacitive node. In one or more examples, the bend component value is computed using a method 800 shown and described later in relation to FIG. 8. In one or more examples, method 800 may be carried out using a bend computation module shown and described later (e.g., a bend computation module 1200 of FIG. 12).

FIG. 7 is a flowchart of a method 700 of median estimation processing for computing a median estimate of a number of capacitive measurement values, according to one or more examples. In one or more examples, the median estimate computed in method 700 may be used as a baseline estimate for the capacitive nodes of the touch sensor. In one or more examples, method 700 may be used to compute the baseline estimate in act 604 of method 600 of FIG. 6. In one or more examples, method 700 may be used to compute the baseline estimate for the computation of the bend component value in act 608 of method 600 of FIG. 6 described earlier.

To begin method 700 of FIG. 7, an array of capacitive measurement values is received or obtained. At an act 702, a median estimate of the capacitive measurement values is computed as a baseline estimate for the capacitive nodes using an iterative median estimation process. In one or more examples, the iterative median estimation may involve, or be referred to as, a split array median calculation.

In one or more examples of act 702, the iterative median estimation process iteratively refines a candidate median estimate by repeatedly partitioning capacitive measurement values into values below and above a current candidate median estimate, until a final median estimate is identified. In one or more specific examples, the iterative median estimation process of act 702 includes acts 704, 706, 708, 710, and 712, as follows.

At an act 704, an initial candidate median estimate is determined as the current candidate median estimate.

At an act 706, the capacitive measurement values are partitioned into a first array and a second array based on comparisons to the current candidate median estimate. The first array includes values greater than the current candidate median estimate, and the second array includes values less than the current candidate median estimate.

At an act 708, a first count of values greater than the current candidate median estimate and a second count of values less than the current candidate median estimate are maintained.

At an act 710, an updated candidate median estimate is determined based at least partially on capacitive measurement values of a selected one of the first array or the second array, where the selected array is associated with a greater one of the first count or the second count.

At an act 712, the partitioning, maintaining, and determining using the selected array are repeated, for example, until the first count and the second count are equal or within a threshold of one another.

In one or more examples, the median estimate is identified to be, or be based on, a last-determined candidate median estimate of the iterative median estimation process (e.g., at least partially responsive to identifying that the first count and the second count are equal or within the threshold of one another).

In one or more examples of act 704, the initial candidate median estimate may be referred to as an initial “guess” of the median of the capacitive measurement values. In one or more examples, the initial candidate median estimate is determined based on at least some of the capacitive measurement values in the initial array. In one or more examples, the initial candidate median estimate is determined at least partially based on an arithmetic mean or average of the capacitive measurement values in the initial array. If the arithmetic mean is used as the initial guess, it will generally lie close to the median for Gaussian-distributed data, and may often be within approximately one standard deviation of the median.

In one or more examples of act 710, the updated candidate median estimate may be referred to as an updated “guess” of the median of the capacitive measurement values. In one or more examples, the updated candidate median estimate is determined based on at least some of the capacitive measurement values in the selected array. In one or more examples, the updated candidate median estimate is determined based on a midrange of the capacitive measurement values in the selected array (e.g., the sum of the maximum value and the minimum value divided by two).

FIG. 8 is a flowchart of a method 800 of interpolation factor processing for computing an interpolation factor for bend morphing, according to one or more examples. In one or more examples, method 800 may be used to compute the interpolation factor used in act 606 of method 600 of FIG. 6 described earlier.

At an act 802, a spatial signal gradient of a respective capacitive node is computed at least partially based on at least some of the capacitive measurement values of the capacitive nodes. At an act 804, an interpolation factor of the respective capacitive node is computed at least partially based on the spatial signal gradient.

In one or more examples of act 802, the spatial signal gradient is implemented as a first-order derivative approximation of the capacitive measurement values in the spatial domain. In one or more examples, the spatial signal gradient includes a (e.g., central) finite-difference approximation of a first-order spatial derivative of the signal across the capacitive nodes.

Accordingly, in one or more examples of act 802, the spatial signal gradient at a respective capacitive node is computed at least partially based on a difference between one or more first capacitive measurement values of one or more respective preceding capacitive nodes relative to (e.g., neighboring and/or immediate adjacent) the respective capacitive node and one or more second capacitive measurement values of one or more respective succeeding capacitive nodes relative to (e.g., neighboring and/or immediate adjacent) the respective capacitive node. In one or more examples, the preceding and succeeding capacitive nodes are along a same drive line as the respective capacitive node. In one or more specific examples, the spatial signal gradient at a capacitive node (k) is at least partially based on the difference between a capacitive measurement value at a capacitive node (k+1) and a capacitive measurement value at a capacitive node (k−1), where k is a positive integer corresponding to a y-node or y-line (i.e., sense node or sense line) index.

In one or more examples of act 804, at an act 806, the interpolation factor is computed at least partially as a linear function of the spatial signal gradient, wherein the interpolation factor decreases as the spatial signal gradient increases. In one or more examples, the interpolation factor has a maximum value when the spatial signal gradient is at zero, and a zero value when the spatial signal gradient is at a maximum gradient threshold. In one or more examples, the interpolation factor derived from the spatial signal gradient is used in bend morph processing to preserve small touch signals (e.g., gloved touches) at the touch sensor.

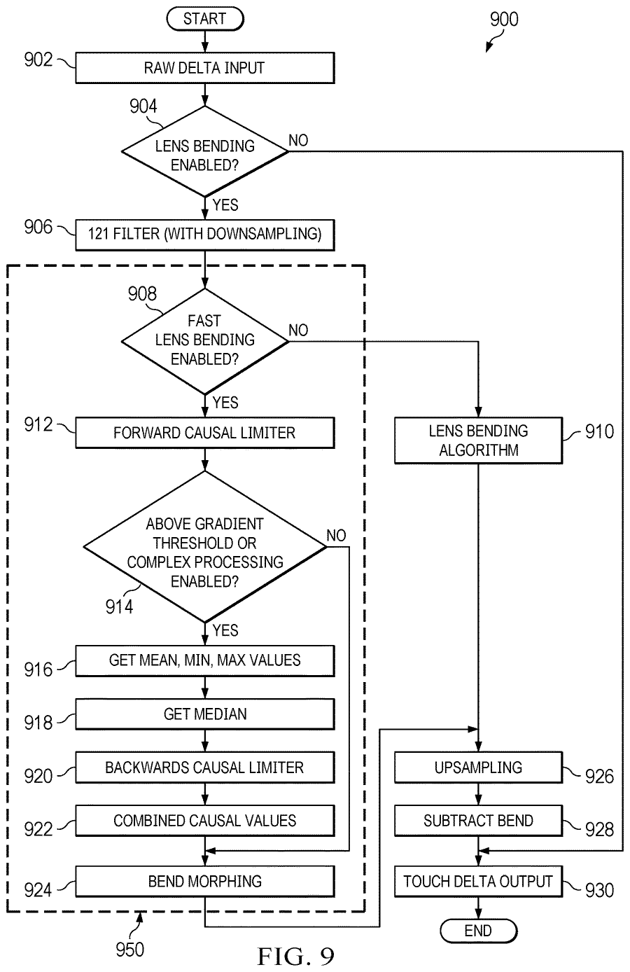

FIG. 9 is a flowchart of a method 900 for capacitive touch processing in a touch sensor, according to one or more examples. In one or more examples, method 900 describes an overarching method of capacitive touch processing with detailed processing steps at a lower processing level. In one or more examples, method 900 includes a “fast” lens bending algorithm that provides functionality and results comparable to those of current state-of-the-art methods while requiring significantly less processing time and power.

At an act 902, raw delta input of the touch sensor is received. At an act 904, if a lens bending algorithm is enabled, then processing continues at an act 906 for touch signal conditioning. If a lens bending algorithm is not enabled, processing continues at a connector B without any touch signal conditioning of the input.

At act 906, the lens bending algorithm begins, in this example, with application of 1-2-1 filtering with downsampling of the raw delta input. In one or more examples, the 1-2-1 filtering with downsampling includes applying a three-tap finite impulse response (FIR) smoothing filter having coefficients [1, 2, 1], optionally normalized, followed by decimation of the filtered signal.

At an act 908, if the “fast” lens bending algorithm is enabled, processing continues at a process 950 for execution of the fast lens bending algorithm. Accordingly, in one or more examples, the algorithm of the disclosure operates on signals in a downsampled phase. If the fast lens bending algorithm is not enabled at act 908, then a standard lens bending algorithm is executed at act 910, where processing continues at a connector A.

At an act 912, the fast lens bending algorithm of process 950 begins, in this example, with application of a forward causal limiter to the filtered raw delta input. In one or more examples, the forward causal limiter processes the filtered raw delta input using only current and past samples to constrain or clip the signal amplitude in real time, for example, limiting rapid excursions while introducing no dependence on future samples.

At an act 914, if an “above gradient” threshold or complex processing is enabled, then processing continues at an act 916 to continue the touch signal conditioning. If the above gradient threshold or complex processing is not enabled at act 914, then several acts are bypassed (i.e., acts 916, 918, 920, and 922 are bypassed) and processing continues at an act 924.

At act 916, initial values to compute a median estimate of a number of capacitive measurement values are determined. In one or more examples, the initial values include an arithmetic mean value of the capacitive measurement values, a maximum value (Max) of the capacitive measurement values, and a minimum value (Min) of the capacitive measurement values. In one or more examples, the mean value can be used as an initial candidate median estimate (e.g., as an “initial guess”) for computing the median estimate, the Max and Min values can be used to update the median estimate (e.g., based on a midrange, or (Max+Min)/2), and a difference of Max−Min can be used as a stopping criterion for stopping the computation (e.g., when the interval width becomes smaller than a tolerance, the median estimate computation will terminate).

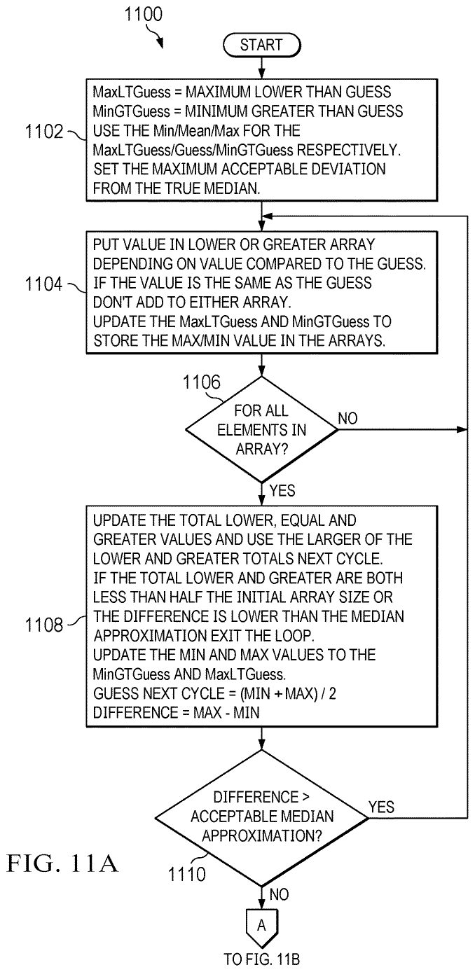

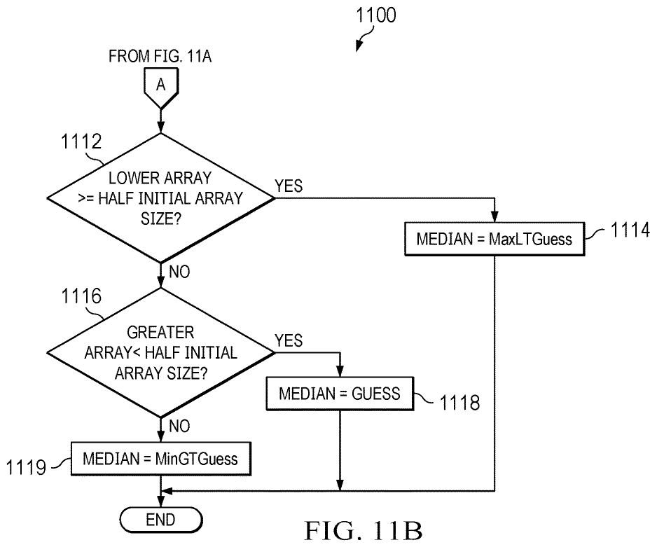

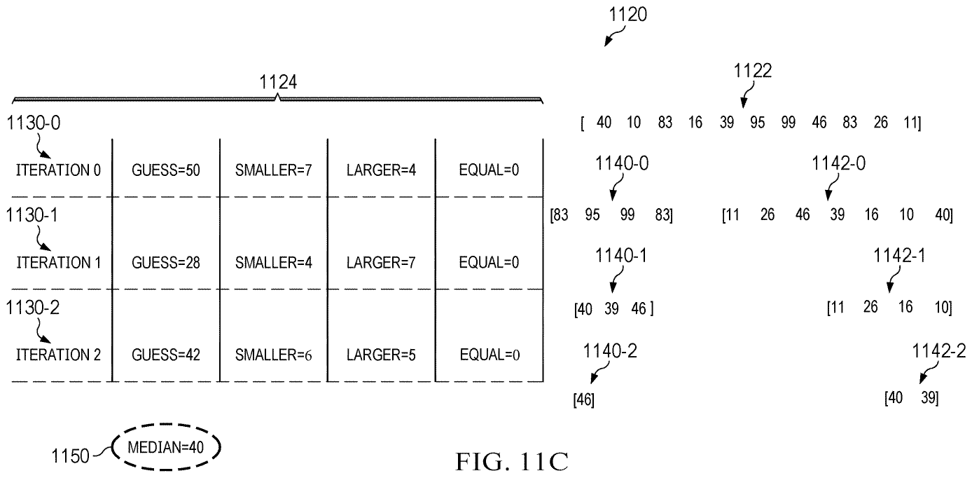

At an act 918, the median estimate of the capacitive measurement values is computed using the initial values obtained in act 916. In one or more examples, the median estimate of the capacitive measurement values is computed by an iterative median estimation process. In one or more examples, the iterative median estimation process iteratively refines a candidate median estimate by repeatedly partitioning capacitive measurement values into values below and above a current candidate median estimate, until a final median estimate is identified. In one or more examples, act 918 is performed according to method 700 of FIG. 7 and/or method 1100 of FIGS. 11A, 11B, and 11C.

In one or more examples, the median estimate of act 918 is used as a baseline estimate of the capacitive nodes. In one or more examples, the baseline estimate is used to compute delta values for the respective capacitive nodes. For example, delta values of the respective capacitive nodes may be computed at least partially based on differences between the capacitive measurement values of the respective capacitive nodes and the baseline estimate.

At an act 920, a backward causal limiter is applied to the inputted values. In one or more examples, the backward causal limiter processes the inputted values using only current and subsequent samples to constrain or clip the signal amplitude in a reverse direction, for example, limiting rapid excursions while introducing no dependence on past samples in the reverse processing direction.

At an act 922, bidirectional limiting is performed which combines outputs of the forward and backward causal limiters to generate a consolidated, bidirectionally constrained signal. In one or more examples, the combined causal values module merges corresponding values from the forward-and backward-limited signals to produce a final signal that satisfies limiting constraints in both directions, for example, reducing rapid excursions while mitigating directional bias introduced by a single causal pass.

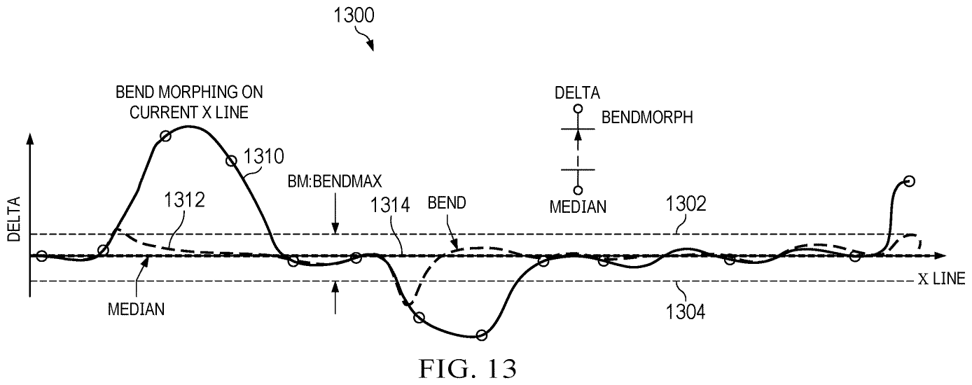

At an act 924, a bend morphing computation is performed to compute a bend component value for respective ones of the capacitive nodes. In one or more examples, the bend component value for a respective capacitive node is at least partially based on a delta value of the respective capacitive node and the baseline estimate. In one or more particular examples, the bend morphing includes computing the bend component value of a respective one of the capacitive nodes at least partially based on an interpolation between the delta value of the respective capacitive node and the baseline estimate according to an interpolation factor of the respective capacitive node. In one or more examples, act 924 is performed in accordance with the process flow arrangement of FIG. 12 and/or the plots of FIGS. 13, 14, and 15 described later below. In one or more examples, act 924 is performed using an interpolation factor computed at least partially based on a spatial signal gradient of the respective capacitive node, according to method 800 of FIG. 8 described earlier.

Continuing processing through connector A, at act 926, upsampling is performed on the preconditioned signal to increase its sampling resolution. In one or more examples, the upsampling includes generating additional samples between existing samples of the preconditioned signal.

At an act 928, the bend component value of a respective capacitive node obtained at act 924 is subtracted from the delta value of the respective capacitive node to obtain a touch signal value. Put another way, a touch signal value of the respective capacitive node is computed at least partially based on a difference between the delta value of the respective capacitive node and the bend component value of the respective capacitive node.

At an act 930, the touch signal value(s) are output as touch delta output. Touch presence at a respective capacitive node can be detected at least partially based on comparing the touch signal value to one or more threshold values.

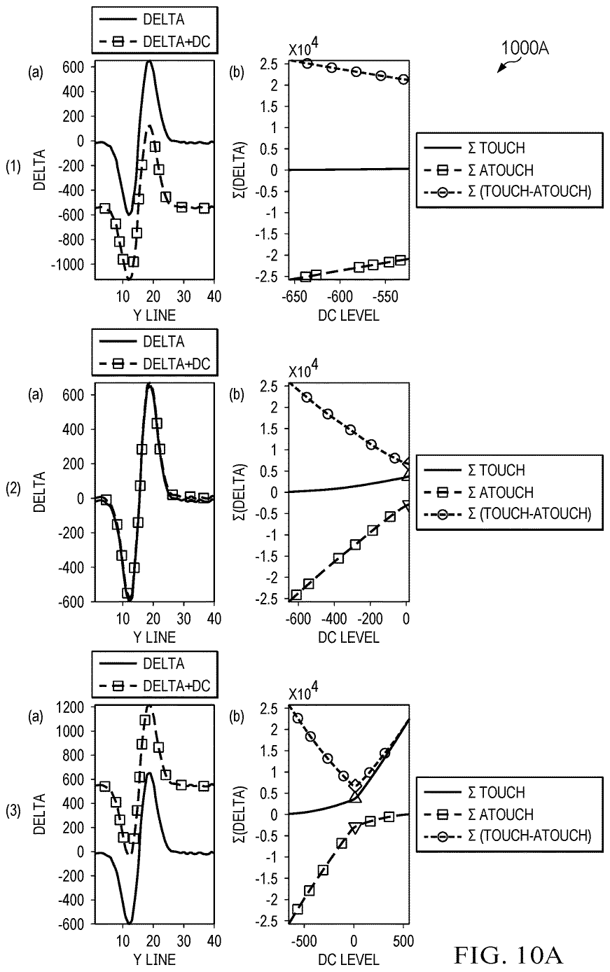

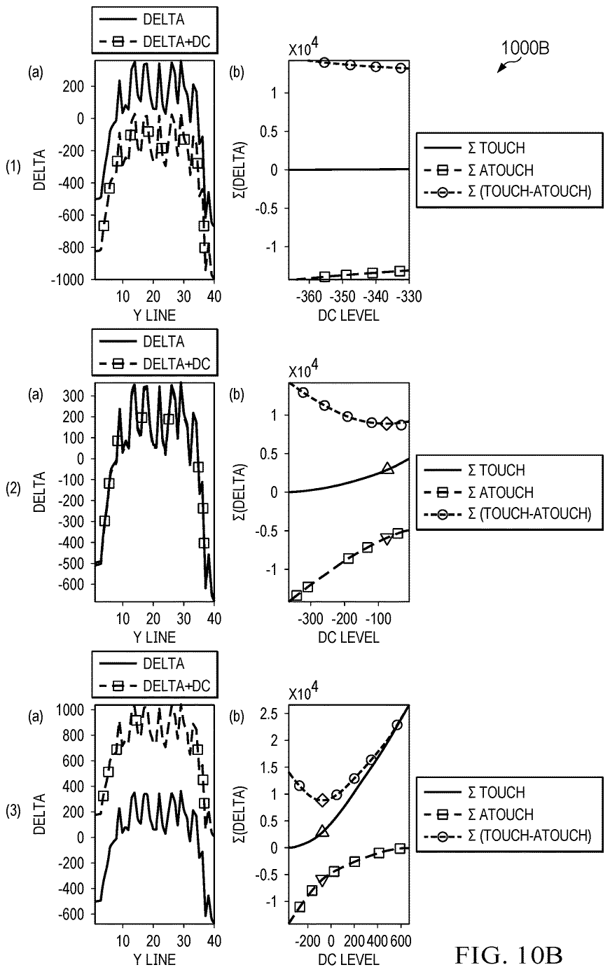

FIGS. 10A and 10B are respective example groups of plots 1000A and 1000B illustrating a relationship between a baseline estimate and a median of capacitive measurement values, according to one or more examples.

In general, the plots of FIGS. 10A and 10B depict touch-related signal components and anti-touch signal components evaluated across varying DC levels, and also visually demonstrate a balancing condition associated with the median. More particularly, each example group of plots 1000A and 1000B includes consecutive plots (1), (2), and (3) corresponding to a DC sweep. Each one of plots (1), (2), and (3) includes: a subplot (a) illustrating Delta and Delta+DC versus Y line; and a subplot (b) illustrating Σ Touch values (solid curve), Σ Anti-Touch values (tick-marked curve), and Σ(Touch−ATouch) values (dotted curve).

As one moves consecutively from plots (1), (2), to (3), the DC level varies during the DC sweep, resulting in a vertical shift of the Delta+DC curve. When the DC level is too low, a larger portion of the signal falls below zero; when the DC level is too high, a larger portion of the signal rises above zero. At an appropriate DC level, the signal is more evenly balanced about zero.

As the DC level changes across plots (1), (2), and (3), the classification of samples into “touch” and “anti-touch” correspondingly changes, and their aggregated sums may vary accordingly. As the DC level increases, a greater portion of the signal is classified as “touch,” whereas as the DC level decreases, a greater portion is classified as “anti-touch.” A DC level corresponding to a balancing of touch and anti-touch contributions provides a suitable estimate of the DC level. More specifically, there exists a DC level at which the opposing contributions are more nearly balanced, and this level corresponds to a minimum of Σ(Touch−ATouch), as illustrated in the plots. In one dimension, the median corresponds to the value that balances data above and below it and, equivalently, minimizes the sum of absolute deviations. When the DC level is offset from this balancing point, one side tends to dominate. When the DC level approaches this balancing point, the opposing contributions are more balanced. The middle plot (2) appears closest to the balancing condition and to a DC estimate that centers the signal.

Accordingly, the DC level at which the difference between the sums of touch and anti-touch values is minimized provides a suitable estimate of the DC level.

FIGS. 11A and 11B form a flowchart of a method 1100 of computing a median estimate of capacitive measurement values as a baseline estimate in a touch sensor, according to one or more examples. In one or more examples, method 1100 describes detailed processing steps of computing the median estimate at a lower processing level.

In one or more examples, method 1100 employs an iterative median estimation process to compute a median estimate of capacitive measurement values. In one or more examples, the iterative median estimation process utilizes a split array to reduce the number of values processed in each iteration. In one or more examples, the iterative median estimation process iteratively refines a candidate median estimate by repeatedly partitioning capacitive measurement values into values below a current candidate median estimate (e.g., assigned to a first array) and values above the current candidate median estimate (e.g., assigned to a second array), until a final median estimate is identified.

At an act 1102, a current candidate median estimate (or current median “Guess”) for an initial array of capacitive measurement values is initialized, together with other processing values for processing. In one or more examples, the “Guess” is initially set to an arithmetic mean of the capacitive measurement values in the initial array. “MaxLTGuess” represents a maximum value “less than” Guess and “MinGTGuess” represents a minimum value “greater than” Guess. In some examples, MaxLTGuess and MinGTGuess are set to, or derived from, respective minimum and maximum values (“Min” and “Max” values, respectively) in the array. A maximum acceptable median approximation or deviation from the true median is also set. The processing loop begins at an act 1104 with use of the initial array of capacitive measurement values.

At an act 1104, a capacitive measurement value in the array is compared to the current Guess. If the value is less than the Guess, the value is assigned to a “lower than” array. If the value is greater than the Guess, the value is assigned to a “greater than” array. If the value equals the Guess, the value is not assigned to either array (or alternatively, the value is assigned to an “equal to” array). MaxLTGuess and MinGTGuess may be updated to store the Max and Min values in the arrays. At an act 1106, a determination is made as to whether all elements (i.e., capacitive measurement values) in the array have been processed. If not, act 1104 is repeated for respective next ones of the values in the array. When all elements have been processed, processing proceeds to act 1108.

At act 1108, respective counts associated with the lower than array, the greater than array, and the equal to array are updated. In one or more examples, the array associated with the largest number of elements (e.g., determined based on the comparisons and counts) is selected for processing in the next cycle. In one or more specific examples, if both the total number of elements in the lower than array and the total number of elements in the greater than array are less than half of the initial array size, or if the difference between the MaxLTGuess and MinGTGuess is lower than the maximum acceptable median approximation, then the processing loop may be exited. The Max and Min values may be updated to MaxLTGuess and MinGTGuess. An updated Guess is computed as (Min+Max)/2, and a Difference is computed as Max−Min.

At an act 1110, a determination is made as to whether the Difference is greater than the maximum acceptable median approximation. If the Difference is greater than the maximum, processing returns to act 1104 for the next iteration using the updated Guess for the selected array (i.e., the selected lower than array or greater than array). If the Difference is not greater than the maximum, processing proceeds through a connector A to an act 1112 of FIG. 11B.

At act 1112, it is determined whether the lower than array is greater than or equal to half of the initial array size. If it is determined that the lower than array is greater than or equal to half of the initial array size at act 1112, then at an act 1114, the final median estimate (“Median”) is set to MaxLTGuess and the processing ends. If it is determined that the lower than array is not greater than or equal to half of the initial array size at act 1112, then at an act 1116, it is determined whether the greater than array is less than half of the initial array size. If it is determined that the greater than array is less than half of the initial array size at act 1116, then at an act 1118, the final median estimate is set to the Guess and the processing ends. If it is determined that the greater than array is not less than half of the initial array size at act 1116, then at an act 1119, the final median estimate is set to MinGTGuess and the processing ends.

FIG. 11C is an example sequence 1120 of successive changes in data values and array contents during an iterative median estimation process, according to one or more examples. In one or more examples, the sequence 1120 of changes in data values and array contents may be representative of those resulting from method 1100 of FIGS. 11A and 11B, or variations thereof.

In FIG. 11C, an initial array 1122 of capacitive measurement values are depicted. Processing values 1124 associated with the capacitive measurement values of initial array 1122 are also depicted. The iterative median estimation process is to determine a median estimate of the capacitive measurement values in initial array 1122. In the specific, non-limiting example, initial array 1122 has eleven (11) elements of capacitive measurement values associated with eleven (11) capacitive nodes along the same drive line (e.g., x-line). In one or more examples, the number of capacitive measurement values to be processed correspond to all of the capacitive nodes along the same single drive line (e.g., between about 7-10 capacitive nodes, or between about 70-80 capacitive nodes, and so on, depending on the arrangement and/or application). In one or more examples, the median estimate to be computed is used as the baseline estimate over (e.g., all of) the capacitive nodes along the same single drive line.

Processing values 1124 include iteration processing values 1130-0 associated with Iteration0. Iteration processing values 1130-0 include an iteration counter=Iteration0 and an initial Guess=50 (e.g., based on the arithmetic mean of the array values in initial array 1122). A comparison of respective array values in initial array 1122 to the Guess=50 results in initial counts including Smaller Than Count=7, Larger Than Count=4, and an Equal To Count=0, and a partitioning of the array values into a greater than array 1140-0 and a lower than array 1142-0. Since the greater total count is the Smaller Than Count=7 associated with less than array 1142-0, less than array 1142-0 is selected for use in the next iteration (e.g., for updating the estimate and partitioning).

Iteration processing values 1130-1 associated with Iteration1 include an iteration counter=Iteration1 and an updated Guess=28 (e.g., based on the midrange of the array values in less than array 1142-0, or (Max+Min)/2). A comparison of respective array values in less than array 1142-0 to the updated Guess=28 results in updated counts including Smaller Than Count=4, Larger Than Count=7, and an Equal To Count=0, and a partitioning of the array values into a greater than array 1140-1 and a lower than array 1142-1. Since the greater total count is the Larger Than Count=7 associated with greater than array 1142-1, greater than array 1142-1 is selected for use in the next iteration (e.g., for updating the estimate and partitioning).

Iteration processing values 1130-2 associated with Iteration2 include an iteration counter=Iteration2 and an updated Guess=42 (e.g., based on the midrange of the array values in greater than array 1140-1, or (Max+Min)/2). A comparison of respective array values in greater than array 1140-1 to the Guess=42 results in updated counts including Smaller Than Count=6, Larger Than Count=5, and an Equal To Count=0, and a partitioning of the array values into a greater than array 1140-2 and a lower than array 1142-2. Since the greater total count is Smaller Than Count=6, lower than array 1142-2 is selected for use in the next (and final) iteration. As the Smaller Than Count=6 is about equal to the Larger Than Count=5, the iterative processing ends with a final median estimate 1150 (e.g., based on the midrange of the array values in lower than array 1142-2, or (Max+Min)/2).

FIG. 12 is a processing flow diagram of a bend compensation module 1200 including a number of interconnected process modules, according to one or more examples. In one or more examples, respective ones of the process modules comprise processor-executable instructions (e.g., software modules) executable by one or more processors (e.g., an MCU and/or DSP of the touch controller). In one or more other examples, the respective ones of the process modules are implemented as software modules (e.g., the processor-executable instructions) with at least portions optionally implemented or accelerated using dedicated hardware.

Bend compensation module 1200 includes a median estimate module 1202, a gradient computation module 1204, an interpolation factor computation module 1206, and a bend component computation module 1208. In one or more examples, bend compensation module 1200 also includes a touch signal component module 1222. In one or more examples, respective ones of the process modules of bend compensation module 1200 have inputs and outputs interconnected in the arrangement depicted in FIG. 12.

In one or more examples, bend compensation module 1200 is adapted to perform some or all of method 600 of FIG. 6 described earlier. In one or more examples, a selector logic 1212 (depicted as multiple switches in FIG. 12) may be used to selectively enable or disable bend compensation functionality in response to a selection signal (e.g., an enable signal 1214). In FIG. 12, selector logic 1212 is depicted in an enabled state to enable bend compensation functionality of bend compensation module 1200.

Capacitive measurement values associated with a number of capacitive nodes are received at an input 1210 of bend compensation module 1200. In particular, the capacitive measurement values are received at median estimate module 1202. Median estimate module 1202 is to compute a median estimate based on the capacitive measurement values. In one or more examples, median estimate module 1202 is to compute the median estimate at least partially according to act 604 of FIG. 6, method 700 of FIG. 7, and/or method 1100 of FIGS. 11A-11C described earlier.

The capacitive measurement values of the capacitive nodes are also received at gradient computation module 1204. Gradient computation module 1204 is to compute a spatial signal gradient for a respective capacitive node based on at least some of the capacitive measurement values. In one or more examples, gradient computation module 1204 is to compute the spatial signal gradient for the respective capacitive node at least partially according to act 804 of FIG. 8 described earlier.

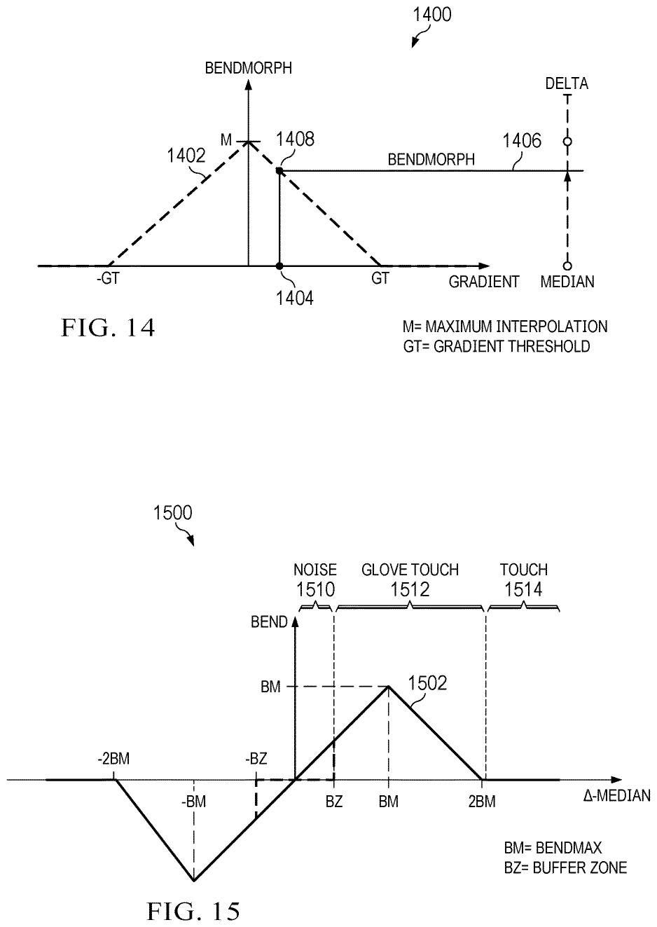

Interpolation factor computation module 1206 is to compute an interpolation factor for the respective capacitive node based on the spatial signal gradient from gradient computation module 1204. In one or more examples, interpolation factor computation module 1206 also uses a Bendmorph parameter 1216 in the processing. In one or more examples, the interpolation factor is computed at least partially as a linear function of the spatial signal gradient, where the interpolation factor decreases as the spatial signal gradient increases. In one or more examples, interpolation factor computation module 1206 is to compute the interpolation factor for the respective capacitive node at least partially according to method 800 of FIG. 8 described earlier and/or plot 1400 of FIG. 14 described later below.

Bend component computation module 1208 is to compute a bend component value for the respective capacitive node based on an interpolation between the delta value of the respective capacitive node and the baseline estimate from median estimate module 1202. The interpolation is performed according to the interpolation factor of the respective capacitive node from interpolation factor computation module 1206. In one or more examples, bend component computation module 1208 also uses a Buffzone (BZ) parameter 1218 and a Bendmax (BM) parameter 1219 in the processing. In one or more examples, bend component computation module 1208 is to compute the bend component value at least partially according to act 608 of FIG. 6, using the interpolation factor computed at least partially according to method 800 of FIG. 8 described earlier, and/or plot 1400 of FIG. 14 and plot 1500 of FIG. 15 described later below. In one or more examples, bend component computation module 1208 uses the interpolation factor derived from the spatial signal gradient to preserve small touch signals (e.g., gloved touches) at the touch sensor.

Touch signal component module 1222 is to provide, at an output 1220, a touch signal value based on a difference between the delta value of the respective capacitive node and the bend component value of the respective capacitive node. In one or more examples, touch presence may be detected at the respective capacitive node based on comparing the touch signal value to one or more threshold values.

FIG. 13 is an example plot 1300 depicting a spatial distribution of capacitive signal values along an X line (or drive line) of capacitive nodes of a touch sensor, and further illustrating bend morphing applied along the X line, according to one or more examples.

In plot 1300, the horizontal axis corresponds to node positions along the X line, and the vertical axis corresponds to signal magnitude (e.g., a capacitive measurement value or a delta value). Curve 1310 represents the capacitive measurement signal across the X line, and line 1314 represents a median baseline estimate of the signal values along the X line. Lines 1302 and 1304 represent upper and lower bend limit bounds (e.g., Bendmax (B) limits, or +Bendmax and −Bendmax) relative to the median baseline estimate. Curve 1312 represents a bend-compensated signal produced by an interpolation-based bend morphing operation.

In one or more examples, the bend morphing computes, for respective nodes, an interpolation factor based at least partially on a spatial signal gradient of curve 1310. Locations exhibiting sharper local spatial variation are associated with an interpolation factor that reduces bend correction, while locations exhibiting smoother spatial variation are associated with an interpolation factor that increases bend correction. In one or more examples, the bend limit bounds cooperate with the gradient-based interpolation factor to substantially constrain the bend-compensated signal (curve 1312) within the range defined by lines 1302 and 1304.

FIG. 14 is an example plot 1400 depicting a relationship between a spatial signal gradient and an interpolation factor used for bend compensation processing, according to one or more examples.

In plot 1400, the horizontal axis represents the spatial signal gradient and the vertical axis represents a bend morphing value (e.g., an interpolation factor or bend morph magnitude). A dashed triangular profile illustrates an example mapping or function between gradient magnitude and bend morphing magnitude. The profile includes a line 1402 having a negative slope indicating a decreasing relationship between the bend morphing magnitude and increasing positive gradient values.

In one or more examples, the bend morphing magnitude increases to a maximum interpolation (M) as the spatial signal gradient approaches zero, and decreases toward zero as the gradient magnitude increases to a gradient threshold (GT). A point 1404 on the gradient axis represents an example spatial signal gradient value. A horizontal line 1406 (“bendmorph”) is used to identify, at a point 1408 on line 1402, a bend morphing value corresponding to the example gradient value. Accordingly, plot 1400 illustrates how the spatial signal gradient influences the interpolation factor used in bend morphing, such that bend compensation is reduced in regions exhibiting larger spatial signal variations and increased in regions exhibiting smaller spatial variations.

FIG. 15 is an example plot 1500 depicting a relationship between a difference signal (Δ−median) and a bend morphing response used in bend compensation processing, according to one or more examples.

In plot 1500, the horizontal axis represents a difference between a delta value and a median baseline estimate (Δ−median), and the vertical axis represents a bend morphing magnitude. A triangular curve 1502 illustrates an example bend morphing response profile. In one or more examples, the bend morphing magnitude is determined based on the difference between the delta value and the median baseline estimate, such that the bend component value may be expressed approximately as α*(Δ−median), where α represents the interpolation factor.

The difference signal (Δ−median) represents the input quantity used to compute the bend component value and provides an indication of how far the measured signal deviates from the baseline estimate. In one or more examples, relatively small values of (Δ−median) correspond to signals that remain close to the baseline estimate, and are therefore more likely associated with bend or noise. Conversely, relatively large values of (Δ−median) correspond to more localized signal deviations that are more likely associated with touch events. The interpolation factor determines the extent to which the difference signal contributes to the bend component value used in bend morphing.

The triangular curve 1502 illustrates how the bend morphing response varies relative to certain parameters, Bendmax (BM) and Bufferzone (BZ). A region 1510 near the origin (e.g., from zero to BZ) corresponds to a noise region in which small signal variations may be attributed primarily to noise or bend effects. A region 1512 (e.g., from BZ to 2BM) corresponds to a gloved touch region in which the signal magnitude exceeds the noise region but remains within a range corresponding to weaker touch signals (e.g., gloved touch). A region 1514 (e.g., from 2BM onward) corresponds to a touch region associated with larger signal magnitudes indicative of stronger touch events.

Accordingly, plot 1500 illustrates how the bend morphing response varies as a function of the difference signal (Δ −median) while incorporating bend limit (BM) and buffer zone (BZ) parameters to distinguish between noise, gloved touch, and touch signal conditions. Bend morphing is reduced toward zero interpolation as the spatial signal gradient increases so that localized touch signals, including weaker touches such as gloved touches, are preserved. Bend morphing is also suppressed near zero difference (Δ −median) to reduce noise sensitivity and unnecessary computation. In addition, bend morphing is limited for signal values more than approximately two Bendmax (BM) away from the median baseline estimate to prevent distortion or breakup of large touch signals.

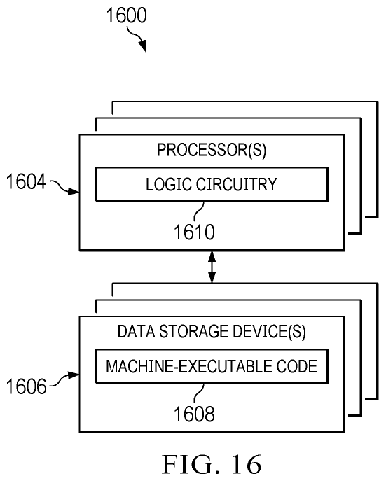

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 16 illustrates non-limiting examples of implementations of functional elements disclosed herein. In some examples, some or all portions of the functional elements disclosed herein may be performed by hardware specially implemented for carrying out the functional elements.

FIG. 16 is a block diagram of circuitry 1600 that, in some examples, may be used to implement various functions, operations, acts, processes, and/or methods disclosed herein. Circuitry 1600 includes one or more processors 1604 (sometimes referred to herein as “processor 1604”) operably coupled to one or more data storage devices (sometimes referred to herein as “storage 1606”). Storage 1606 includes machine-executable code 1608 stored thereon, and processor 1604 include a logic circuitry 1610. Machine-executable code 1608 includes information describing functional elements that may be implemented by (e.g., performed by) logic circuitry 1610. Logic circuitry 1610 is adapted to implement (e.g., perform) the functional elements described by machine-executable code 1608. Circuitry 1600, when executing the functional elements described by machine-executable code 1608, should be considered as special purpose hardware for carrying out functional elements disclosed herein. In some examples, processor 1604 may perform the functional elements described by machine-executable code 1608 sequentially, concurrently (e.g., on one or more different hardware platforms), or in one or more parallel process streams.

When implemented by logic circuitry 1610 of processor 1604, machine-executable code 1608 adapts processor 1604 to perform operations of examples disclosed herein. For example, machine-executable code 1608 may be to adapt processor 1604 to perform at least a portion or a totality of methods or processes described herein (e.g., methods or processes associated with FIGS. 6, 7, 8, 9, 10A-10B, 11A-11C, and 12-15).

Processor 1604 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1608 (e.g., software code, firmware code, hardware descriptions) related to examples of the disclosure. It is noted that a general-purpose processor (may also be referred to herein as a host processor or simply a host) may be a microprocessor, but in the alternative, processor 1604 may include any conventional processor, controller, microcontroller, or state machine. Processor 1604 may also be implemented as a combination of computing devices, such as a combination of a DSP and a microprocessor, a plurality of microprocessors, one or more microprocessors in conjunction with a DSP core, or any other such configuration.

In some examples, storage 1606 includes volatile data storage (e.g., random-access memory (RAM)), non-volatile data storage (e.g., Flash memory, a hard disc drive, a solid-state drive, erasable programmable read-only memory (EPROM), etc.). In some examples, processor 1604 and storage 1606 may be implemented into a single device (e.g., a semiconductor device product, a system on chip (SOC), etc.). In some examples, processor 1604 and storage 1606 may be implemented into separate devices.

In some examples, machine-executable code 1608 may include computer-readable instructions (e.g., software code, firmware code). By way of non-limiting example, the computer-readable instructions may be stored by storage 1606, accessed directly by processor 1604, and executed by processor 1604 using at least logic circuitry 1610. Also by way of non-limiting example, the computer-readable instructions may be stored on storage 1606, transferred to a memory device (not shown) for execution, and executed by processor 1604 using at least logic circuitry 1610. Accordingly, in some examples, logic circuitry 1610 includes electrically configurable logic circuitry 1610.

In some examples, machine-executable code 1608 may describe hardware (e.g., circuitry) to be implemented in logic circuitry 1610 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog, and/or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1610 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1608 may include an HDL, an RTL, a GL description, a mask level description, other hardware description, or any combination thereof.

In examples where machine-executable code 1608 includes a hardware description (at any level of abstraction), a system (not shown, but including storage 1606) may be to implement the hardware description described by machine-executable code 1608. By way of non-limiting example, processor 1604 may include a programmable logic device (e.g., an FPGA or a PLC) and logic circuitry 1610 may be electrically controlled to implement circuitry corresponding to the hardware description into logic circuitry 1610. Also by way of non-limiting example, logic circuitry 1610 may include hard-wired logic manufactured by a manufacturing system (not shown, but including storage 1606) according to the hardware description of machine-executable code 1608.

Regardless of whether machine-executable code 1608 includes computer-readable instructions or a hardware description, logic circuitry 1610 is adapted to perform the functional elements described by machine-executable code 1608 when implementing the functional elements of machine-executable code 1608. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ,” or “one or more of A, B, and C, etc. ,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method comprising: receiving capacitive measurement values of a number of capacitive nodes of a touch sensor; computing, as a baseline estimate, a median estimate of the capacitive measurement values of the capacitive nodes; computing, for respective capacitive nodes, a delta value at least partially based on differences between the capacitive measurement values of the respective capacitive nodes and the baseline estimate; and computing a bend component value of a respective one of the capacitive nodes at least partially based on an interpolation between the delta value of the respective capacitive node and the baseline estimate according to an interpolation factor of the respective capacitive node.

Example 2: The method according to Example 1, comprising: computing a touch signal value of the respective capacitive node at least partially based on a difference between the delta value of the respective capacitive node and the bend component value of the respective capacitive node; and detecting touch presence at the respective capacitive node at least partially based on comparing the touch signal value to one or more threshold values.

Example 3: The method according to Examples 1 and 2, wherein: computing, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

Example 4: The method according to any of Examples 1 through 3, wherein the iterative median estimation process comprises: determining an initial candidate median estimate as the current candidate median estimate; partitioning the capacitive measurement values into a first array and a second array based on comparisons to the current candidate median estimate, the first array including values greater than the current candidate median estimate, the second array including values less than the current candidate median estimate; maintaining a first count of values greater than the current candidate median estimate and a second count of values less than the current candidate median estimate; determining an updated candidate median estimate at least partially based on the capacitive measurement values of a selected one of the first array or the second array, the selected array associated with a greater one of the first count or the second count; and repeating the partitioning, maintaining, and determining at least partially using the selected array, until the first count and the second count are equal or within a threshold of one another.

Example 5: The method according to any of Examples 1 through 4, comprising: computing a spatial signal gradient of the respective capacitive node at least partially based on at least some of the capacitive measurement values; and computing the interpolation factor of the respective capacitive node at least partially as a linear function of the spatial signal gradient, wherein the interpolation factor decreases as the spatial signal gradient increases.

Example 6: The method according to any of Examples 1 through 5, wherein computing the spatial signal gradient of the respective capacitive node comprises: computing the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node.

Example 7: The method according to any of Examples 1 through 6, wherein the method is performed by one or more processors executing processor-executable instructions stored in a non-transitory computer readable medium.

Example 8: An apparatus comprising: a touch controller to: receive capacitive measurement values of a number of capacitive nodes of a capacitive touch sensor; compute, as a baseline estimate, a median estimate of the capacitive measurement values of the capacitive nodes; compute, for respective capacitive nodes, a delta value at least partially based on differences between the capacitive measurement values of the respective capacitive nodes and the baseline estimate; and for the respective capacitive nodes: compute a bend component value of the respective capacitive node at least partially based on an interpolation between the delta value of the respective capacitive node and the baseline estimate according to an interpolation factor of the respective capacitive node; and compute a touch signal value of the respective capacitive node at least partially based on a difference between the delta value of the respective capacitive node and the bend component value of the respective capacitive node.

Example 9: The apparatus according to Example 8, wherein: the touch controller is to, for the respective ones of the capacitive nodes: detect touch presence at the respective capacitive node at least partially based on comparing the touch signal value to one or more threshold values.

Example 10: The apparatus according to Examples 8 and 9, wherein: the touch controller is to compute, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

Example 11: The apparatus according to any of Examples 8 through 10, wherein: the touch controller is to perform the iterative median estimation process including to: determine an initial candidate median estimate as the current candidate median estimate; partition the capacitive measurement values into a first array and a second array based on comparisons to the current candidate median estimate, the first array including values greater than the current candidate median estimate, the second array including values less than the current candidate median estimate; maintain a first count of values greater than the current candidate median estimate and a second count of values less than the current candidate median estimate; determine an updated candidate median estimate at least partially based on the capacitive measurement values of a selected one of the first array or the second array, the selected array associated with a greater one of the first count or the second count; and repeat the partitioning, maintaining, and determining at least partially using the selected array, until the first count and the second count are equal or within a threshold of one another.

Example 12: The apparatus according to any of Examples 8 through 11, wherein: the touch controller is to: compute a spatial signal gradient of the respective capacitive node at least partially based on at least some of the capacitive measurement values; and compute the interpolation factor of the respective capacitive node at least partially as a linear function of the spatial signal gradient, wherein the interpolation factor decreases as the spatial signal gradient increases.

Example 13: The apparatus according to any of Examples 8 through 12, comprising: the capacitive touch sensor comprising a number of vertically-stacked layers including: a drive layer, the drive layer including a number of drive electrode lines extending in a first direction, capacitive nodes being associated with one of the drive electrode lines of the drive layer; and a sense layer, the sense layer including a number of sense electrode lines extending in a second direction, the second direction substantially perpendicular to the first direction, the sense electrode lines intersecting the drive electrode lines to define an array of capacitive nodes at which changes in capacitance are sensed.

Example 14: The apparatus according to any of Examples 8 through 13, wherein: the touch controller is to compute the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node, the one or more preceding capacitive nodes and the one or more succeeding capacitive nodes along a same drive line as the respective capacitive node.

Example 15: An apparatus comprising: a capacitive touch system including: a capacitive touch sensor, the capacitive touch sensor including a number of vertically-stacked layers including a drive layer and a sense layer, the drive layer including a number of drive electrode lines extending in a first direction, the sense layer including a number of sense electrode lines extending in a second direction substantially perpendicular to the first direction, the sense electrode lines intersecting the drive electrode lines to define an array of capacitive nodes at which changes in capacitance are sensed; and a touch controller operably coupled to the capacitive touch sensor, the touch controller to: receive capacitive measurement values of a number of capacitive nodes associated with one of the drive electrode lines; compute, as a baseline estimate, a median estimate of the capacitive measurement values of the capacitive nodes; compute, for respective capacitive nodes, a delta value at least partially based on differences between the capacitive measurement values of the respective capacitive nodes and the baseline estimate; and for respective capacitive nodes: compute a bend component value of the respective capacitive node at least partially based on an interpolation between the delta value of the respective capacitive node and the baseline estimate according to an interpolation factor of the respective capacitive node; compute a touch signal value of the respective capacitive node at least partially based on a difference between the delta value of the respective capacitive node and the bend component value of the respective capacitive node; and detect touch presence at the respective capacitive node at least partially based on comparing the touch signal value to one or more threshold values.

Example 16: The apparatus according to Example 15, wherein: the touch controller is to: for respective next ones of the drive electrode lines, repeat the receiving of the capacitive measurement values, the computing of the median estimate as the baseline estimate, and the computing of the delta values; and for respective capacitive nodes of the respective next ones of the drive electrode lines, repeat the computing of the bend component value and the computing of the touch signal value.

Example 17: The apparatus according to Examples 15 and 16, wherein: the touch controller is to compute, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

Example 18: The apparatus according to any of Examples 15 through 17, wherein: the touch controller is to perform the iterative median estimation process including to: determine an initial candidate median estimate as the current candidate median estimate; partition the capacitive measurement values into a first array and a second array based on comparisons to the current candidate median estimate, the first array including values greater than the current candidate median estimate, the second array including values less than the current candidate median estimate; maintain a first count of values greater than the current candidate median estimate and a second count of values less than the current candidate median estimate; determine an updated candidate median estimate at least partially based on the capacitive measurement values of a selected one of the first array or the second array, the selected array associated with a greater one of the first count or the second count; and repeat the partitioning, maintaining, and determining at least partially using the selected array, until the first count and the second count are equal or within a threshold of one another.

Example 19: The apparatus according to any of Examples 15 through 18, wherein: the touch controller is to: compute a spatial signal gradient of the respective capacitive node at least partially based on at least some of the capacitive measurement values; and compute the interpolation factor of the respective capacitive node at least partially as a linear function of the spatial signal gradient, wherein the interpolation factor decreases as the spatial signal gradient increases.

Example 20: The apparatus according to any of Examples 15 through 19, wherein: the touch controller is to compute the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node, the one or more preceding capacitive nodes and the one or more succeeding capacitive nodes along a same drive line as the respective capacitive node.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
receiving capacitive measurement values of a number of capacitive nodes of a touch sensor;
computing, as a baseline estimate, a median estimate of the capacitive measurement values of the capacitive nodes;
computing, for respective capacitive nodes, a delta value at least partially based on differences between the capacitive measurement values of the respective capacitive nodes and the baseline estimate; and
computing a bend component value of a respective one of the capacitive nodes at least partially based on an interpolation between the delta value of the respective capacitive node and the baseline estimate according to an interpolation factor of the respective capacitive node.

2. The method of claim 1, comprising:
computing a touch signal value of the respective capacitive node at least partially based on a difference between the delta value of the respective capacitive node and the bend component value of the respective capacitive node; and
detecting touch presence at the respective capacitive node at least partially based on comparing the touch signal value to one or more threshold values.

3. The method of claim 1, wherein:
computing, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

4. The method of claim 3, wherein the iterative median estimation process comprises:
determining an initial candidate median estimate as the current candidate median estimate;
partitioning the capacitive measurement values into a first array and a second array based on comparisons to the current candidate median estimate, the first array including values greater than the current candidate median estimate, the second array including values less than the current candidate median estimate;
maintaining a first count of values greater than the current candidate median estimate and a second count of values less than the current candidate median estimate;
determining an updated candidate median estimate at least partially based on the capacitive measurement values of a selected one of the first array or the second array, the selected array associated with a greater one of the first count or the second count; and
repeating the partitioning, maintaining, and determining at least partially using the selected array, until the first count and the second count are equal or within a threshold of one another.

5. The method of claim 1, comprising:
computing a spatial signal gradient of the respective capacitive node at least partially based on at least some of the capacitive measurement values; and
computing the interpolation factor of the respective capacitive node at least partially as a linear function of the spatial signal gradient, wherein the interpolation factor decreases as the spatial signal gradient increases.

6. The method of claim 5, wherein computing the spatial signal gradient of the respective capacitive node comprises:
computing the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node.

7. The method of claim 1, wherein the method is performed by one or more processors executing processor-executable instructions stored in a non-transitory computer readable medium.

8. An apparatus comprising:
a touch controller to:
receive capacitive measurement values of a number of capacitive nodes of a capacitive touch sensor;
compute, as a baseline estimate, a median estimate of the capacitive measurement values of the capacitive nodes;
compute, for respective capacitive nodes, a delta value at least partially based on differences between the capacitive measurement values of the respective capacitive nodes and the baseline estimate; and
for the respective capacitive nodes:
compute a bend component value of the respective capacitive node at least partially based on an interpolation between the delta value of the respective capacitive node and the baseline estimate according to an interpolation factor of the respective capacitive node; and
compute a touch signal value of the respective capacitive node at least partially based on a difference between the delta value of the respective capacitive node and the bend component value of the respective capacitive node.

9. The apparatus of claim 8, wherein:
the touch controller is to, for the respective ones of the capacitive nodes:
detect touch presence at the respective capacitive node at least partially based on comparing the touch signal value to one or more threshold values.

10. The apparatus of claim 9, wherein:
the touch controller is to compute, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

11. The apparatus of claim 10, wherein:
the touch controller is to perform the iterative median estimation process including to:
determine an initial candidate median estimate as the current candidate median estimate;
partition the capacitive measurement values into a first array and a second array based on comparisons to the current candidate median estimate, the first array including values greater than the current candidate median estimate, the second array including values less than the current candidate median estimate;
maintain a first count of values greater than the current candidate median estimate and a second count of values less than the current candidate median estimate;
determine an updated candidate median estimate at least partially based on the capacitive measurement values of a selected one of the first array or the second array, the selected array associated with a greater one of the first count or the second count; and
repeat the partitioning, maintaining, and determining at least partially using the selected array, until the first count and the second count are equal or within a threshold of one another.

12. The apparatus of claim 8, wherein:
the touch controller is to:
compute a spatial signal gradient of the respective capacitive node at least partially based on at least some of the capacitive measurement values; and
compute the interpolation factor of the respective capacitive node at least partially as a linear function of the spatial signal gradient, wherein the interpolation factor decreases as the spatial signal gradient increases.

13. The apparatus of claim 12, comprising:
the capacitive touch sensor comprising a number of vertically-stacked layers including:
a drive layer, the drive layer including a number of drive electrode lines extending in a first direction, capacitive nodes being associated with one of the drive electrode lines of the drive layer; and
a sense layer, the sense layer including a number of sense electrode lines extending in a second direction, the second direction substantially perpendicular to the first direction, the sense electrode lines intersecting the drive electrode lines to define an array of capacitive nodes at which changes in capacitance are sensed.

14. The apparatus of claim 13, wherein:
the touch controller is to compute the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node, the one or more preceding capacitive nodes and the one or more succeeding capacitive nodes along a same drive line as the respective capacitive node.

15. An apparatus comprising:
a capacitive touch system including:
a capacitive touch sensor, the capacitive touch sensor including a number of vertically-stacked layers including a drive layer and a sense layer, the drive layer including a number of drive electrode lines extending in a first direction, the sense layer including a number of sense electrode lines extending in a second direction substantially perpendicular to the first direction, the sense electrode lines intersecting the drive electrode lines to define an array of capacitive nodes at which changes in capacitance are sensed; and
a touch controller operably coupled to the capacitive touch sensor, the touch controller to:
receive capacitive measurement values of a number of capacitive nodes associated with one of the drive electrode lines;
compute, as a baseline estimate, a median estimate of the capacitive measurement values of the capacitive nodes;
compute, for respective capacitive nodes, a delta value at least partially based on differences between the capacitive measurement values of the respective capacitive nodes and the baseline estimate; and
for respective capacitive nodes:
compute a bend component value of the respective capacitive node at least partially based on an interpolation between the delta value of the respective capacitive node and the baseline estimate according to an interpolation factor of the respective capacitive node;
compute a touch signal value of the respective capacitive node at least partially based on a difference between the delta value of the respective capacitive node and the bend component value of the respective capacitive node; and
detect touch presence at the respective capacitive node at least partially based on comparing the touch signal value to one or more threshold values.

16. The apparatus of claim 15, wherein:
the touch controller is to:
for respective next ones of the drive electrode lines, repeat the receiving of the capacitive measurement values, the computing of the median estimate as the baseline estimate, and the computing of the delta values; and
for respective capacitive nodes of the respective next ones of the drive electrode lines, repeat the computing of the bend component value and the computing of the touch signal value.

17. The apparatus of claim 15, wherein:
the touch controller is to compute, as the baseline estimate, the median estimate of the capacitive measurement values using an iterative median estimation process, the iterative median estimation process to iteratively refine a candidate median estimate at least partially based on a repeated partitioning of capacitive measurement values into values below and above a current candidate median estimate.

18. The apparatus of claim 17, wherein:
the touch controller is to perform the iterative median estimation process including to:
determine an initial candidate median estimate as the current candidate median estimate;
partition the capacitive measurement values into a first array and a second array based on comparisons to the current candidate median estimate, the first array including values greater than the current candidate median estimate, the second array including values less than the current candidate median estimate;
maintain a first count of values greater than the current candidate median estimate and a second count of values less than the current candidate median estimate;
determine an updated candidate median estimate at least partially based on the capacitive measurement values of a selected one of the first array or the second array, the selected array associated with a greater one of the first count or the second count; and
repeat the partitioning, maintaining, and determining at least partially using the selected array, until the first count and the second count are equal or within a threshold of one another.

19. The apparatus of claim 15, wherein:
the touch controller is to:
compute a spatial signal gradient of the respective capacitive node at least partially based on at least some of the capacitive measurement values; and
compute the interpolation factor of the respective capacitive node at least partially as a linear function of the spatial signal gradient, wherein the interpolation factor decreases as the spatial signal gradient increases.

20. The apparatus of claim 19, wherein:
the touch controller is to compute the spatial signal gradient of the respective capacitive node at least partially based on a difference between one or more first capacitive measurement values of one or more preceding capacitive nodes relative to the respective capacitive node and one or more second capacitive measurement values of one or more succeeding capacitive nodes relative to the respective capacitive node, the one or more preceding capacitive nodes and the one or more succeeding capacitive nodes along a same drive line as the respective capacitive node.
